(19) United States
(12) Patent Application Publication
(10) Pub. No.: US 2025/0308463 A1
(43) Pub. Date: Oct. 2, 2025

(54) GATE DRIVE CIRCUIT AND DISPLAY PANEL

(71) Applicant: Yungu (Gu’an) Technology Co., Ltd., Langfang (CN)

(72) Inventors: Enqing GUO, Langfang (CN); Cuili GAI, Langfang (CN); Junfeng LI, Langfang (CN); Rubo XING, Langfang (CN); Fa-Hsyang CHEN, Langfang (CN)

(73) Assignee: Yungu (Gu’an) Technology Co., Ltd., Langfang (CN)

(21) Appl. No.: 19/234,172

(22) Filed: Jun. 10, 2025

Related U.S. Application Data
(63) Continuation of application No. PCT/CN2023/101863, filed on Jun. 21, 2023.

(30) Foreign Application Priority Data
Dec. 15, 2022 (CN) 202211615909.9

(51) Int. Cl. G09G 3/3266; G09G 3/3233

(52) U.S. Cl. CPC G09G 3/3266; G09G 3/3233; G09G 2310/0286; G09G 2310/06; G09G 2320/02; G09G 2330/023

(57) ABSTRACT

Disclosed are a gate drive circuit and a display panel. The gate drive circuit includes an output control module, a first transistor (T1), a second transistor (T2), and a voltage regulation module. The output control module is configured to control the first transistor (T1) and the second transistor (T2) to be alternately turned on, to alternately transmit a first output signal and a second output signal to an output terminal (O1) of the gate drive circuit. A first gate of the dual-gate transistor is connected to the output control module. The voltage regulation module is connected to a second gate of the dual-gate transistor, and is configured to regulate a voltage of the second gate of the dual-gate transistor, thereby regulating a threshold voltage of the dual-gate transistor and solving a problem of waveform distortion of a gate drive signal.

### CROSS-REFERENCE TO RELATED APPLICATIONS

The present application is a continuation of International Application No. PCT/CN2023/101863 filed on Jun. 21, 2023, which claims priority to Chinese Patent Application No. 202211615909.9, filed on Dec. 15, 2022 and entitled “GATE DRIVE CIRCUIT AND DISPLAY PANEL”, both of which are hereby incorporated by reference in their entireties.

### FIELD

Embodiments of the present application relate to the field of display technologies, for example, to a gate drive circuit and a display panel.

### BACKGROUND

With the continuous development of display technologies, people have increasingly high requirements for performance of display panels. The display panel includes a gate drive circuit for generating a gate drive signal. In the related art, there is distortion of a waveform of the gate drive signal output by the gate drive circuit, affecting a display effect of the display panel.

### SUMMARY

Embodiments of the present application provide a gate drive circuit and a display panel to solve the problem of waveform distortion of a gate drive signal, thereby improving a display effect of the display panel.

An embodiment of the present application provides a gate drive circuit, including: an output control module, a first transistor, and a second transistor. The output control module is connected to a gate of the first transistor and a gate of the second transistor. A first electrode of the first transistor is connected to a first output signal. A second electrode of the first transistor is connected to an output terminal of the gate drive circuit. A first electrode of the second transistor is connected to a second output signal. A second electrode of the second transistor is connected to the output terminal of the gate drive circuit. The output control module is configured to control the first transistor and the second transistor to be alternately conducted, to alternately transmit the first output signal and the second output signal to the output terminal of the gate drive circuit. At least one of the first transistor and the second transistor is a dual-gate transistor, and a first gate of the dual-gate transistor is connected to the output control module. The gate drive circuit further includes a voltage regulation module that is connected to a second gate of the dual-gate transistor and configured to regulate a voltage of the second gate of the dual-gate transistor.

An embodiment of the present application provides a display panel, including a plurality of gate drive circuits described above. The plurality of gate drive circuits are connected in a cascading manner.

According to the gate drive circuit and the display panel provided in the embodiments of the present application, the output control module controls the first transistor and the second transistor to be alternately conducted, to alternately transmit the first output signal and the second output signal to the output terminal of the gate drive circuit as a gate drive signal; and at least one of the first transistor and the second transistor is configured as the dual-gate transistor, so that the voltage regulation module can regulate a threshold voltage of the dual-gate transistor by regulating the voltage of the second gate of the dual-gate transistor when the dual-gate transistor is conducted, to improve a driving capability of the dual-gate transistor, thereby improving a driving capability of the gate drive signal output by the gate drive circuit, and solving the problem of waveform distortion of the gate drive signal. In addition, the voltage regulation module can further regulate the threshold voltage of the dual-gate transistor by regulating the voltage of the second gate of the dual-gate transistor when the dual-gate transistor is cut off, to suppress a leakage current of the dual-gate transistor, thereby reducing power consumption of the dual-gate transistor caused by the leakage current, further solving the problem of waveform distortion of the gate drive signal, and helping improve a display effect of the display panel.

### BRIEF DESCRIPTION OF THE DRAWINGS

FIG. 1 is a schematic diagram of a structure of a gate drive circuit according to an embodiment of the present application;

FIG. 2 is a schematic diagram of a structure of another gate drive circuit according to an embodiment of the present application;

FIG. 3 is a schematic diagram of a structure of another gate drive circuit according to an embodiment of the present application;

FIG. 4 is a schematic diagram of a structure of another gate drive circuit according to an embodiment of the present application;

FIG. 5 is a schematic diagram of a structure of another gate drive circuit according to an embodiment of the present application;

FIG. 6 is a schematic diagram of a structure of another gate drive circuit according to an embodiment of the present application;

FIG. 7 is a schematic diagram of a structure of another gate drive circuit according to an embodiment of the present application;

FIG. 8 is a schematic diagram of a structure of another gate drive circuit according to an embodiment of the present application;

FIG. 9 is a schematic diagram of a structure of another gate drive circuit according to an embodiment of the present application;

FIG. 10 is a schematic diagram of a structure of another gate drive circuit according to an embodiment of the present application;

FIG. 11 is a schematic diagram of a structure of another gate drive circuit according to an embodiment of the present application;

FIG. 12 is a schematic diagram of a structure of another gate drive circuit according to an embodiment of the present application;

FIG. 13 is a schematic diagram of a structure of another gate drive circuit according to an embodiment of the present application;

FIG. 14 is a schematic diagram of a structure of another gate drive circuit according to an embodiment of the present application;

FIG. 15 is a schematic diagram of a structure of another gate drive circuit according to an embodiment of the present application;

FIG. 16 is a schematic diagram of a structure of another gate drive circuit according to an embodiment of the present application;

FIG. 17 is a schematic diagram of a structure of another gate drive circuit according to an embodiment of the present application;

FIG. 18 is a schematic diagram of driving timing of a gate drive circuit according to an embodiment of the present application;

FIG. 19 is a schematic diagram of a comparison between waveforms of leakage currents and a comparison between waveforms of gate drive signals according to an embodiment of the present application;

FIG. 20 is a schematic diagram of a comparison between waveforms of gate drive signals according to an embodiment of the present application;

FIG. 21 is a schematic diagram of a structure of another gate drive circuit according to an embodiment of the present application;

FIG. 22 is a schematic diagram of a structure of another gate drive circuit according to an embodiment of the present application;

FIG. 23 is a schematic diagram of a structure of another gate drive circuit according to an embodiment of the present application; and

FIG. 24 is a schematic diagram of a structure of another gate drive circuit according to an embodiment of the present application.

### DETAILED DESCRIPTION OF THE EMBODIMENTS

There is usually distortion of a waveform of a gate drive signal output by a gate drive circuit, affecting a display effect of a display panel. The inventor finds based on research that causes for the above problem are as follows. In the gate drive circuit, two output transistors such as a first output transistor and a second output transistor that are connected to a gate drive signal output terminal of the gate drive circuit are usually disposed, a first electrode of the first output transistor may be connected to a low level signal, a first electrode of the second output transistor may be connected to a high level signal, a second electrode of the first output transistor and a second electrode of the second output transistor are both connected to the gate drive signal output terminal of the gate drive circuit, and the gate drive signal output terminal of the gate drive circuit can alternately output a high level and a low level by controlling the first output transistor and the second output transistor to be alternately conducted. However, there is usually a large leakage current in the output transistor. For example, when an N-type indium gallium zinc oxide (IGZO) is used as the output transistor, a threshold voltage tends to be relatively negative, and the output transistor cannot be completely cut off, resulting in a large leakage current problem. As a result, power consumption is caused, and a waveform of the gate drive signal distorts. For example, when the second output transistor is cut off, and the first output transistor is conducted and transmits a low level signal to the gate drive signal output terminal, if there is a leakage current in the second output transistor, a potential of a low level signal output from the gate drive signal output terminal is affected. As a result, a waveform of the gate drive signal is affected, and the second output transistor has power consumption due to the leakage current. In addition, there is also a problem of insufficient driving capability of the output transistor, which causes the level signal transmitted to the gate drive signal output terminal of the gate drive circuit by the output transistor to be distorted. As a result, the waveform of the gate drive signal is still distorted, finally affecting the display effect of the display panel.

An embodiment of the present application provides a gate drive circuit. FIG. 1 is a schematic diagram of a structure of a gate drive circuit according to an embodiment of the present application. Referring to FIG. 1, the gate drive circuit includes: an output control module 10, a first transistor T1, a second transistor T2, and at least one voltage regulation module 20.

The output control module 10 is connected to a gate of a first transistor T1 and a gate of a second transistor T2. A first electrode of the first transistor T1 is connected to a first output signal, and a second electrode of the first transistor T1 is connected to an output terminal O1 of the gate drive circuit. A first electrode of the second transistor T2 is connected to a second output signal, and a second electrode of the second transistor T2 is connected to the output terminal O1 of the gate drive circuit. The output control module 10 is configured to control the first transistor T1 and the second transistor T2 to be alternately conducted, to alternately transmit the first output signal and the second output signal to the output terminal O1 of the gate drive circuit. At least one of the first transistor T1 and the second transistor T2 is a dual-gate transistor. A first gate of the dual-gate transistor is connected to the output control module 10.

The voltage regulation module 20 is connected to a second gate of the dual-gate transistor. The voltage regulation module 20 is configured to regulate a voltage of the second gate of the dual-gate transistor.

One of the first output signal and the second output signal includes a relatively low level, and the other of the first output signal and the second output signal includes a relatively high level. In FIG. 1, an example in which a third level signal VGL is used as the first output signal and a second level signal VGH is used as the second output signal is used for illustration. In this case, one of the third level signal VGL and the second level signal VGH includes a relatively low level, and the other of the third level signal VGL and the second level signal VGH includes a relatively high level. The output control module 10 controls the first transistor T1 and the second transistor T2 to be alternately conducted, so that the first transistor T1 and the second transistor T2 can alternately transmit signals to the output terminal O1 of the gate drive circuit, and the output terminal O1 of the gate drive circuit outputs a gate drive signal with alternate high levels and low levels.

At least one of the first transistor T1 and the second transistor T2 is a dual-gate transistor. The dual-gate transistor may be a dual-gate transistor including a top gate and a bottom gate. A first gate of the dual-gate transistor may be one of the top gate and the bottom gate, and a second gate of the dual-gate transistor may be the other of the top gate and the bottom gate. For example, the first gate of the dual-gate transistor may be the top gate, and the second gate of the dual-gate transistor may be the bottom gate. When the first transistor T1 is a dual-gate transistor, a first gate of the first transistor T1 is connected to the output control module 10, and a second gate of the first transistor T1 is connected to the voltage regulation module 20, to control a voltage of the first gate of the first transistor T1 through the output control module 10, thereby controlling the first transistor T1 to be conducted or cut off, and regulating a voltage of the second gate of the first transistor T1 through the voltage regulation module 20. Similarly, when the second transistor T2 is a dual-gate transistor, a first gate of the second transistor T2 is connected to the output control module 10, and a second gate of the second transistor T2 is connected to the voltage regulation module 20, to control a voltage of the first gate of the second transistor T2 through the output control module 10, thereby controlling the second transistor T2 to be conducted or cut off, and regulating a voltage of the second gate of the second transistor T2 through the voltage regulation module 20.

It can be learned based on a characteristic of the dual-gate transistor that a threshold voltage of the dual-gate transistor is affected by a potential applied to the second gate of the dual-gate transistor. When the dual-gate transistor is an N-type transistor, a more positive potential of the second gate of the dual-gate transistor indicates a more negative threshold voltage of the dual-gate transistor; and a more negative potential of the second gate of the dual-gate transistor indicates a more positive threshold voltage of the dual-gate transistor. When the dual-gate transistor is a P-type transistor, a more positive potential of the second gate of the dual-gate transistor indicates a more negative threshold voltage of the dual-gate transistor; and a more negative potential of the second gate of the dual-gate transistor indicates a more positive threshold voltage of the dual-gate transistor.

When the first transistor T1 is a dual-gate transistor, it may be configured that the voltage regulation module 20 includes a first voltage regulation module 20a, and the first voltage regulation module 20a is connected to the second gate of the first transistor T1. When the second transistor T2 is a dual-gate transistor, it may be configured that the voltage regulation module 20 includes a second voltage regulation module 20b, and the second voltage regulation module 20b is connected to the second gate of the second transistor T2. In an embodiment, as shown in FIG. 1, it may be configured that the first transistor T1 and the second transistor T2 are both dual-gate transistors, the second gate of the first transistor T1 is connected to the first voltage regulation module 20a, and the second gate of the second transistor T2 is connected to the second voltage regulation module 20b. In another embodiment, when either of the first transistor T1 and the second transistor T2 is a dual-gate transistor, only the voltage regulation module 20 correspondingly connected to the dual-gate transistor may be disposed. When the first transistor T1 and the second transistor T2 are both dual-gate transistors, only the voltage regulation module 20 correspondingly connected to one of the dual-gate transistors may alternatively be disposed.

Optionally, the voltage regulation module 20 is configured to regulate the voltage of the second gate of the dual-gate transistor when the dual-gate transistor is conducted, to improve a driving capability of the dual-gate transistor, and/or regulate the voltage of the second gate of the dual-gate transistor when the dual-gate transistor is cut off, to suppress a leakage current of the dual-gate transistor.

A working principle of the gate drive circuit shown in FIG. 1 is described below by using an example in which the first transistor T1 and the second transistor T2 are both N-type transistors, the third level signal VGL includes a low level, and the second level signal VGH includes a high level.

When the output control module 10 controls the first transistor T1 to be cut off and controls the second transistor T2 to be conducted, the second level signal VGH is transmitted to the output terminal O1 of the gate drive circuit through the second transistor T2, and a gate drive signal output by the gate drive circuit is a high level signal. The voltage regulation module 20 corresponding to the second transistor T2 may transmit a potential greater than 0 V to the second gate of the second transistor T2 when the second transistor T2 is conducted, to raise the voltage of the second gate of the second transistor T2 and in turn make a threshold voltage of the second transistor T2 tend to be negative. When the voltage of the first gate of the second transistor T2 remains unchanged, a more negative threshold voltage of the second transistor T2 indicates a larger current of the second transistor T2. Therefore, a driving capability of the second transistor T2 can be improved, to solve the problem of waveform distortion of the gate drive signal. In addition, the voltage regulation module 20 corresponding to the first transistor T1 may transmit a potential less than 0 V to the second gate of the first transistor T1 when the first transistor T1 is cut off, to reduce the voltage of the second gate of the first transistor T1, so that a threshold voltage of the first transistor T1 tends to be positive. When the voltage of the first gate of the first transistor T1 remains unchanged, a more positive threshold voltage of the first transistor T1 indicates a less negative voltage of the first gate required for cutting off the first transistor T1, to avoid a case in which the first transistor T1 is not cut off when the voltage of the first gate of the first transistor T1 is not low enough, that is, the first transistor T1 is still in a sub-threshold region or in a conducted state. Therefore, when the first transistor T1 is cut off, the potential less than 0 V is transmitted to the second gate of the first transistor T1, to reduce the voltage of the second gate of the first transistor T1, so that the threshold voltage of the first transistor T1 tends to be positive, and the first transistor T1 can be more easily cut off. This helps avoid a leakage current problem caused by impossibility to completely cut off the first transistor T1, to suppress a leakage current of the first transistor T1, thereby further solving the problem of waveform distortion of the gate drive signal, and helping reduce power consumption of the first transistor T1 caused by the leakage current.

Similarly, when the output control module 10 controls the second transistor T2 to be cut off and controls the first transistor T1 to be conducted, the third level signal VGL is transmitted to the output terminal O1 of the gate drive circuit through the first transistor T1, and a gate drive signal output by the gate drive circuit is a low level signal. The voltage regulation module 20 corresponding to the first transistor T1 may transmit a potential greater than 0 V to the second gate of the first transistor T1 when the first transistor T1 is conducted, to raise the voltage of the second gate of the first transistor T1 and in turn make the threshold voltage of the first transistor T1 tend to be negative, thereby improving a driving capability of the first transistor T1 and solving the problem of waveform distortion of the gate drive signal. In addition, the voltage regulation module 20 corresponding to the second transistor T2 may transmit a potential less than 0 V to the second gate of the second transistor T2 when the second transistor T2 is cut off, to reduce the voltage of the second gate of the second transistor T2, so that the threshold voltage of the second transistor T2 tends to be positive. This helps avoid the leakage current problem caused by impossibility to completely cut off the second transistor T2, to suppress a leakage current of the second transistor T2, thereby further solving the problem of waveform distortion of the gate drive signal, and helping reduce power consumption of the second transistor T2 caused by the leakage current.

In another embodiment, when the first transistor T1 and the second transistor T2 are both P-type transistors, the voltage regulation module 20 may transmit a potential less than 0 V to a second gate of a corresponding dual-gate transistor (i.e., the first transistor T1 or the second transistor T2) when the dual-gate transistor is conducted, to reduce a voltage of the second gate of the dual-gate transistor and in turn make a threshold voltage of the dual-gate transistor tend to be positive, thereby improving a driving capability of the dual-gate transistor, and solving the problem of waveform distortion of the gate drive signal. The voltage regulation module 20 transmits a potential greater than 0 V to the second gate of the dual-gate transistor when the dual-gate transistor is cut off, to raise the voltage of the second gate of the dual-gate transistor and in turn make the threshold voltage of the dual-gate transistor tend to be negative, thereby suppressing a leakage current of the dual-gate transistor, reducing power consumption of the dual-gate transistor caused by the leakage current, and further solving the problem of waveform distortion of the gate drive signal.

The above embodiment is described by using only a case in which the voltage regulation module 20 regulates the voltage of the second gate of the corresponding dual-gate transistor when the dual-gate transistor is conducted, to improve the driving capability of the dual-gate transistor, and the voltage regulation module 20 regulates the voltage of the second gate of the corresponding dual-gate transistor when the dual-gate transistor is cut off, to suppress the leakage current of the dual-gate transistor as an example. In another embodiment, it may alternatively be configured that the voltage of the second gate of the corresponding dual-gate transistor is regulated only through the voltage regulation module 20 when the dual-gate transistor is conducted, to improve the driving capability of the dual-gate transistor; or it may be configured that the voltage of the second gate of the corresponding dual-gate transistor is regulated only through the voltage regulation module 20 when the dual-gate transistor is cut off, to suppress the leakage current of the dual-gate transistor. Both of the above two configuration manners help solve the problem of waveform distortion of the gate drive signal of the gate drive circuit.

In conclusion, according to the embodiments of the present application, the output control module controls the first transistor and the second transistor to be alternately conducted, to alternately transmit the first output signal and the second output signal to the output terminal of the gate drive circuit as the gate drive signal; and at least one of the first transistor and the second transistor is configured as the dual-gate transistor, so that the voltage regulation module can regulate the threshold voltage of the dual-gate transistor by regulating the voltage of the second gate of the dual-gate transistor when the dual-gate transistor is conducted, to improve the driving capability of the dual-gate transistor, thereby improving a driving capability of the gate drive signal output by the gate drive circuit, and solving the problem of waveform distortion of the gate drive signal. In addition, the voltage regulation module can further regulate the threshold voltage of the dual-gate transistor by regulating the voltage of the second gate of the dual-gate transistor when the dual-gate transistor is cut off, to suppress the leakage current of the dual-gate transistor, thereby reducing the power consumption of the dual-gate transistor caused by the leakage current, further solving the problem of waveform distortion of the gate drive signal, and helping improve a display effect of the display panel.

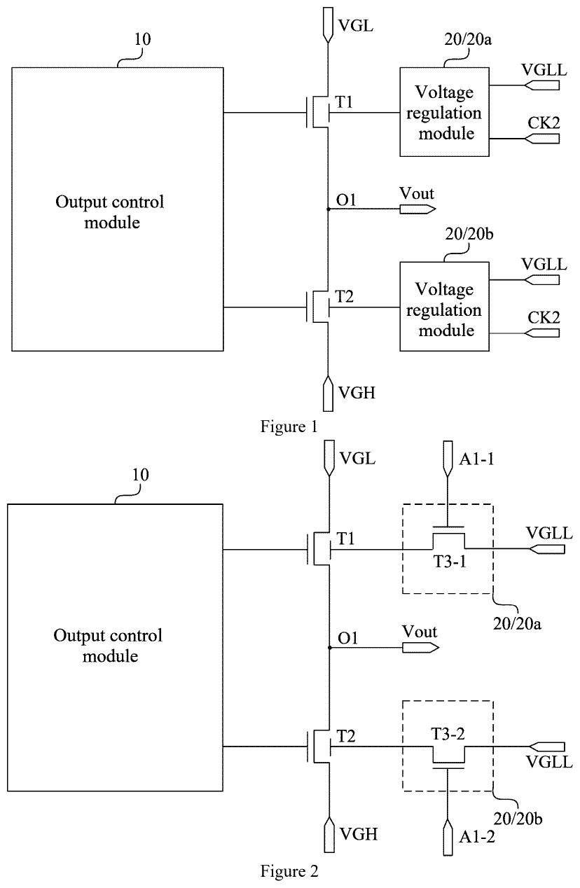

FIG. 2 is a schematic diagram of a structure of another gate drive circuit according to an embodiment of the present application. Referring to FIG. 2, in an embodiment, it may be configured that a control terminal of a voltage regulation module 20 is connected to a first control signal, a first terminal of the voltage regulation module 20 is connected to a first level signal VGLL, and a second terminal of the voltage regulation module 20 is connected to a second gate of a dual-gate transistor. The voltage regulation module 20 is configured to transmit the first level signal VGLL to the second gate of the dual-gate transistor in response to the first control signal when the dual-gate transistor is cut off, to suppress a leakage current of the dual-gate transistor.

For example, when a first transistor T1 is a dual-gate transistor, a first voltage regulation module 20a corresponding to the first transistor T1 may be disposed. A control terminal of the first voltage regulation module 20a is connected to a first control signal A1-1, and a second terminal of the first voltage regulation module 20a is connected to a second gate of the first transistor T1. The first voltage regulation module 20a is conducted in response to the first control signal A1-1 when the first transistor T1 is cut off, to transmit the first level signal VGLL to the second gate of the first transistor T1 through the first voltage regulation module 20a. A voltage of the second gate of the first transistor T1 is regulated through the first level signal VGLL, to regulate a threshold voltage of the first transistor T1, thereby helping ensure that the first transistor T1 is completely cut off, to suppress a leakage current of the first transistor T1. Similarly, when a second transistor T2 is a dual-gate transistor, a second voltage regulation module 20b corresponding to the second transistor T2 may be disposed. A control terminal of the second voltage regulation module 20b is connected to a first control signal A1-2, and a second terminal of the second voltage regulation module 20b is connected to a second gate of the second transistor T2. The second voltage regulation module 20b is conducted in response to the first control signal A1-2 when the second transistor T2 is cut off, to transmit the first level signal VGLL to the second gate of the second transistor T2 through the second voltage regulation module 20b. A voltage of the second gate of the second transistor T2 is regulated through the first level signal VGLL, to regulate a threshold voltage of the second transistor T2, thereby helping ensure that the second transistor T2 is completely cut off, to suppress a leakage current of the second transistor T2. Optionally, when the first transistor T1 or the second transistor T2 is an N-type dual-gate transistor, a potential of the first level signal VGLL may be a potential less than 0 V.

Still referring to FIG. 2, the voltage regulation module 20 includes a third transistor. A gate of the third transistor is connected to the first control signal, a first electrode of the third transistor is connected to the first level signal VGLL, and a second electrode of the third transistor is connected to the second gate of the dual-gate transistor. For example, when the first transistor T1 is a dual-gate transistor, it may be configured that the first voltage regulation module 20a includes a third transistor T3-1. A gate of the third transistor T3-1 is connected to the first control signal A1-1, a first electrode of the third transistor T3-1 is connected to the first level signal VGLL, and a second electrode of the third transistor T3-1 is connected to the second gate of the first transistor T1. When the second transistor T2 is a dual-gate transistor, it may be configured that the second voltage regulation module 20b includes a third transistor T3-2. A gate of the third transistor T3-2 is connected to the first control signal A1-2, a first electrode of the third transistor T3-2 is connected to the first level signal VGLL, and a second electrode of the third transistor T3-2 is connected to the second gate of the second transistor T2.

In another embodiment, the first level signal VGLL may alternatively be replaced with a clock signal. The clock signal includes a signal with alternate high levels and low levels. For example, the clock signal includes a high potential greater than 0 V and a low potential less than 0 V. When a dual-gate transistor connected to the voltage regulation module 20 is an N-type transistor, the voltage regulation module 20 (or the third transistor) may transmit a low potential less than 0 V in the clock signal to a second gate of the dual-gate transistor when the dual-gate transistor is cut off, to regulate a threshold voltage of the dual-gate transistor, thereby helping ensure that the dual-gate transistor is completely cut off, to suppress a leakage current of the dual-gate transistor. When a dual-gate transistor connected to the voltage regulation module 20 is a P-type transistor, the voltage regulation module 20 (or the third transistor) may transmit a high potential greater than 0 V in the clock signal to a second gate of the dual-gate transistor when the dual-gate transistor is cut off, to regulate a threshold voltage of the dual-gate transistor, thereby helping ensure that the dual-gate transistor is completely cut off, to suppress a leakage current of the dual-gate transistor.

In another embodiment, the first level signal VGLL may alternatively be replaced with a clock signal, and a capacitor is disposed between the second electrode of the third transistor and the second gate of the dual-gate transistor. For example, when the first transistor T1 is a dual-gate transistor, a capacitor may be disposed between the second electrode of the third transistor T3-1 in the first voltage regulation module 20a and the second gate of the first transistor T1, to control the third transistor T3-1 to transmit the clock signal to the capacitor when the first transistor T1 is cut off. The capacitor couples the voltage of the second gate of the first transistor T1 based on a jump of the clock signal, to regulate the threshold voltage of the first transistor T1, thereby ensuring that the first transistor T1 is completely cut off, to suppress the leakage current of the first transistor T1. Similarly, when the second transistor T2 is a dual-gate transistor, a capacitor may be disposed between the second electrode of the third transistor T3-2 in the second voltage regulation module 20b and the second gate of the second transistor T2, and the first level signal VGLL is replaced with a clock signal.

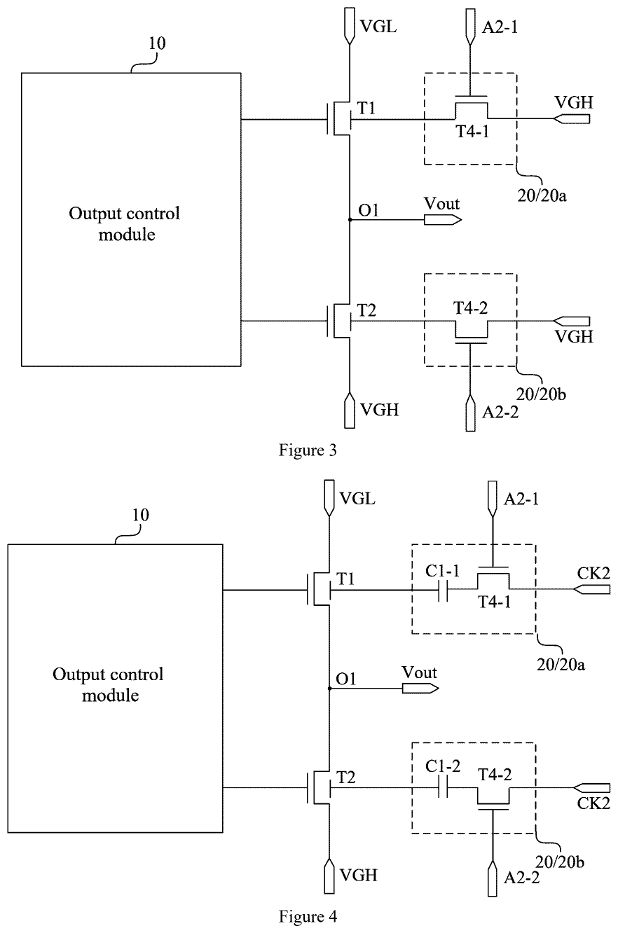

FIG. 3 is a schematic diagram of a structure of another gate drive circuit according to an embodiment of the present application. Referring to FIG. 3, in an embodiment, it may be configured that a control terminal of a voltage regulation module 20 is connected to a second control signal, a first terminal of the voltage regulation module 20 is connected to a preset signal, and a second terminal of the voltage regulation module 20 is connected to a second gate of a dual-gate transistor. The voltage regulation module 20 is configured to regulate, through the preset signal, a voltage of the second gate of the dual-gate transistor in response to the second control signal when the dual-gate transistor is conducted, to improve a driving capability of the dual-gate transistor.

The preset signal may be a fixed level signal or a jump level signal. The jump level signal means that a level of the signal jumps between a high level and a low level. For example, the jump level signal includes a clock signal.

For example, a second level signal VGH may be used as the preset signal. When a first transistor T1 is a dual-gate transistor, a first voltage regulation module 20a corresponding to the first transistor T1 may be disposed. A control terminal of the first voltage regulation module 20a is connected to a second control signal A2-1, and a second terminal of the first voltage regulation module 20a is connected to a second gate of the first transistor T1. The first voltage regulation module 20a is conducted in response to the second control signal A2-1 when the first transistor T1 is conducted, to transmit the second level signal VGH to the second gate of the first transistor T1 through the first voltage regulation module 20a. A voltage of the second gate of the first transistor T1 is regulated through the second level signal VGH, to regulate a threshold voltage of the first transistor T1, thereby improving a driving capability of the first transistor T1. Similarly, when a second transistor T2 is a dual-gate transistor, a second voltage regulation module 20b corresponding to the second transistor T2 may be disposed. A control terminal of the second voltage regulation module 20b is connected to a second control signal A2-2, and a second terminal of the second voltage regulation module 20b is connected to a second gate of the second transistor T2. The second voltage regulation module 20b is conducted in response to the second control signal A2-2 when the second transistor T2 is conducted, to transmit the second level signal VGH to the second gate of the second transistor T2 through the second voltage regulation module 20b. A voltage of the second gate of the second transistor T2 is regulated through the second level signal VGH, to regulate a threshold voltage of the second transistor T2, thereby improving a driving capability of the second transistor T2. Optionally, when the first transistor T1 or the second transistor T2 is an N-type dual-gate transistor, a potential of the second level signal VGH may be a potential greater than 0 V.

Still referring to FIG. 3, the voltage regulation module 20 includes a fourth transistor. A gate of the fourth transistor is connected to the second control signal, and a first electrode of the fourth transistor is connected to the preset signal. The fourth transistor is configured to transmit the preset signal to the second gate of the dual-gate transistor in response to the second control signal. For example, when the first transistor T1 is a dual-gate transistor, it may be configured that the first voltage regulation module 20a includes a fourth transistor T4-1. A gate of the fourth transistor T4-1 is connected to the second control signal A2-1, a first electrode of the fourth transistor T4-1 is connected to the second level signal VGH, and a second electrode of the fourth transistor T4-1 is connected to the second gate of the first transistor T1. When the second transistor T2 is a dual-gate transistor, it may be configured that the second voltage regulation module 20b includes a fourth transistor T4-2. A gate of the fourth transistor T4-2 is connected to the second control signal A2-2, a first electrode of the fourth transistor T4-2 is connected to the second level signal VGH, and a second electrode of the fourth transistor T4-2 is connected to the second gate of the second transistor T2.

FIG. 4 is a schematic diagram of a structure of another gate drive circuit according to an embodiment of the present application. Referring to FIG. 4, based on the above embodiment, the voltage regulation module 20 further includes a first capacitor. The first capacitor is connected between a second electrode of the fourth transistor and the second gate of the dual-gate transistor. When the first transistor T1 is a dual-gate transistor, it may be configured that the first voltage regulation module 20a further includes a first capacitor C1-1. The first capacitor C1-1 is connected between the second electrode of the fourth transistor T4-1 and the second gate of the first transistor T1. When the preset signal is a clock signal, for example, a second clock signal CK2, and the first transistor T1 is an N-type transistor, the fourth transistor T4-1 may be conducted in response to the second control signal A2-1 when the first transistor T1 is conducted, to transmit the second clock signal CK2 to the first capacitor C1-1 through the fourth transistor T4-1, so that the first capacitor C1-1 couples a potential of the second gate of the first transistor T1 when a level of the second clock signal CK2 jumps from a low level to a high level. In this way, the voltage of the second gate of the first transistor T1 can be raised, to make the threshold voltage of the first transistor T1 tend to be negative, thereby improving the driving capability of the first transistor T1. In addition, when the level of the second clock signal CK2 is a low level, there is a voltage difference between the second gate of the first transistor T1 and the first electrode of the fourth transistor T4-1. The first capacitor C1-1 is disposed between the second electrode of the fourth transistor T4-1 and the second gate of the first transistor T1, and a current transmission path between the second electrode of the fourth transistor T4-1 and the second gate of the first transistor T1 is blocked through the first capacitor C1-1, to prevent the low level in the second clock signal CK2 from being transmitted to the second gate of the first transistor T1, thereby not affecting an operating state of the first transistor T1. Similarly, when the second transistor T2 is a dual-gate transistor, it may be configured that the second voltage regulation module 20b further includes a first capacitor C1-2. The first capacitor C1-2 is connected between the second electrode of the fourth transistor T4-2 and the second gate of the second transistor T2. A function of the first capacitor C1-2 is similar to a function of the first capacitor C1-1. Details are not described again.

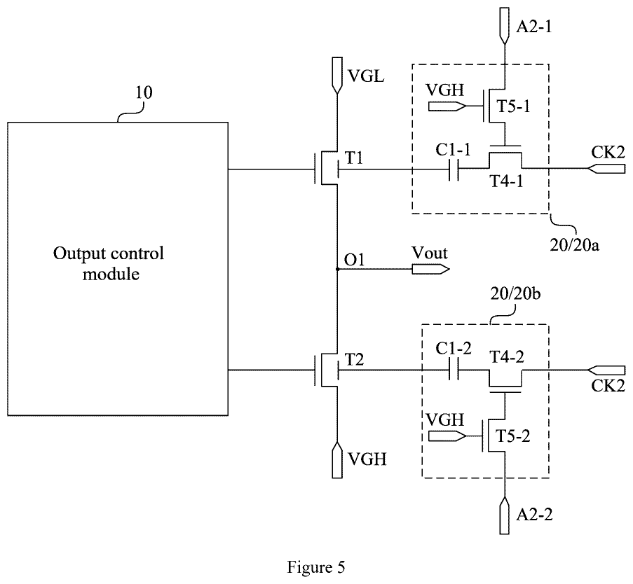

FIG. 5 is a schematic diagram of a structure of another gate drive circuit according to an embodiment of the present application. Referring to FIG. 5, optionally, the voltage regulation module 20 further includes a fifth transistor. The fifth transistor is connected between the gate of the fourth transistor and a second control signal terminal. The fifth transistor remains in a normally conducted state. When the first transistor T1 is a dual-gate transistor, it may be configured that the first voltage regulation module 20a further includes a fifth transistor T5-1. The fifth transistor T5-1 is connected between the gate of the fourth transistor T4-1 and the second control signal terminal. The second control signal A2-1 is connected to the gate of the fourth transistor T4-1 through the fifth transistor T5-1. The fifth transistor T5-1 helps block an extremely low/extremely high potential in the second control signal A2-1, to prevent the extremely low/extremely high potential in the second control signal A2-1 from being transmitted to the fourth transistor T4-1, thereby not causing damage to the fourth transistor T4-1 and not affecting the normal operation of the fourth transistor T4-1. Similarly, when the second transistor T2 is a dual-gate transistor, it may be configured that the second voltage regulation module 20b further includes a fifth transistor T5-2. The fifth transistor T5-2 is connected between the gate of the fourth transistor T4-2 and the second control signal terminal. The second control signal A2-2 is connected to the gate of the fourth transistor T4-2 through the fifth transistor T5-2. A function of the fifth transistor T5-2 is similar to a function of the fifth transistor T5-1. Details are not described again.

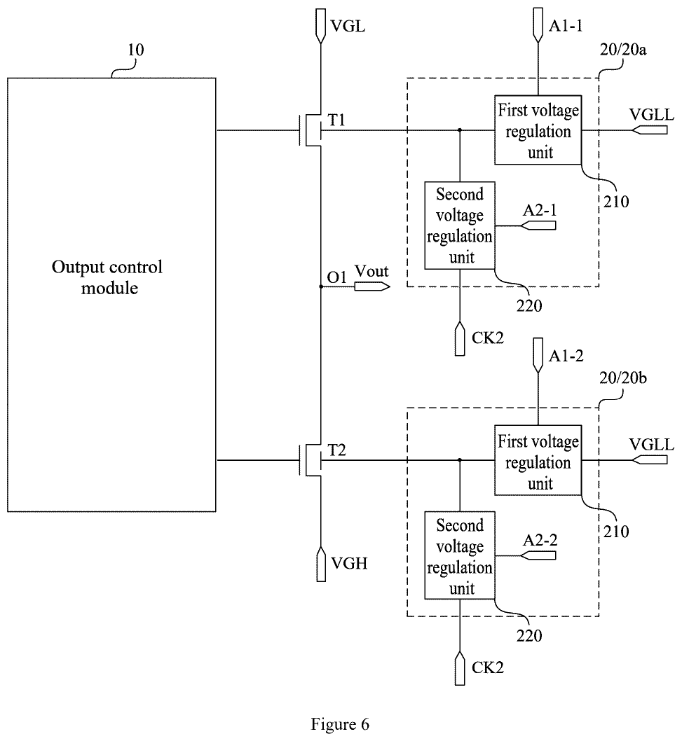

FIG. 6 is a schematic diagram of a structure of another gate drive circuit according to an embodiment of the present application. Referring to FIG. 6, optionally, in another embodiment, it may alternatively be configured that a voltage regulation module 20 includes: a first voltage regulation unit 210 and a second voltage regulation unit 220. A control terminal of the first voltage regulation unit 210 is connected to a first control signal, a first terminal of the first voltage regulation unit 210 is connected to a first level signal VGLL, and a second terminal of the first voltage regulation unit 210 is connected to a second gate of a dual-gate transistor. The first voltage regulation unit 210 is configured to transmit the first level signal VGLL to the second gate of the dual-gate transistor in response to the first control signal when the dual-gate transistor is cut off. A control terminal of the second voltage regulation unit 220 is connected to a second control signal, a first terminal of the second voltage regulation unit 220 is connected to a preset signal, and a second terminal of the second voltage regulation unit 220 is connected to the second gate of the dual-gate transistor. The second voltage regulation unit 220 is configured to regulate, through the preset signal, a voltage of the second gate of the dual-gate transistor in response to the second control signal when the dual-gate transistor is conducted.

For example, when a first transistor T1 is a dual-gate transistor, it may be configured that the voltage regulation module 20 includes a first voltage regulation module 20a, and the first voltage regulation module 20a is connected to a second gate of the first transistor T1. In the first voltage regulation module 20a, the control terminal of the first voltage regulation unit 210 is connected to a first control signal A1-1, the second terminal of the first voltage regulation unit 210 is connected to the second gate of the first transistor T1, the control terminal of the second voltage regulation unit 220 is connected to a second control signal A2-1, and the second terminal of the second voltage regulation unit 220 is connected to the second gate of the first transistor T1. In this way, when an output control module 10 controls the first transistor T1 to be cut off, the first voltage regulation unit 210 may transmit the first level signal VGLL to the second gate of the first transistor T1 in response to the first control signal A1-1. A voltage of the second gate of the first transistor T1 is regulated through the first level signal VGLL, to regulate a threshold voltage of the first transistor T1, thereby suppressing a leakage current of the first transistor T1. When the output control module 10 controls the first transistor T1 to be conducted, the second voltage regulation unit 220 may transmit a signal related to the preset signal to the second gate of the first transistor T1 in response to the second control signal A2-1. The voltage of the second gate of the first transistor T1 is regulated through the signal related to the preset signal, to regulate the threshold voltage of the first transistor T1, thereby improving a driving capability of the first transistor T1.

Similarly, when the second transistor T2 is a dual-gate transistor, it may be configured that the voltage regulation module 20 includes a second voltage regulation module 20b, and the second voltage regulation module 20b is connected to a second gate of the second transistor T2. In the second voltage regulation module 20b, the control terminal of the first voltage regulation unit 210 is connected to a first control signal A1-2, the second terminal of the first voltage regulation unit 210 is connected to the second gate of the second transistor T2, the control terminal of the second voltage regulation unit 220 is connected to a second control signal A2-2, and the second terminal of the second voltage regulation unit 220 is connected to the second gate of the second transistor T2. A working principle of the first voltage regulation unit 210 and the second voltage regulation unit 220 in the second voltage regulation module 20b is similar to a working principle of the first voltage regulation unit 210 and the second voltage regulation unit 220 in the first voltage regulation module 20a. Details are not described again.

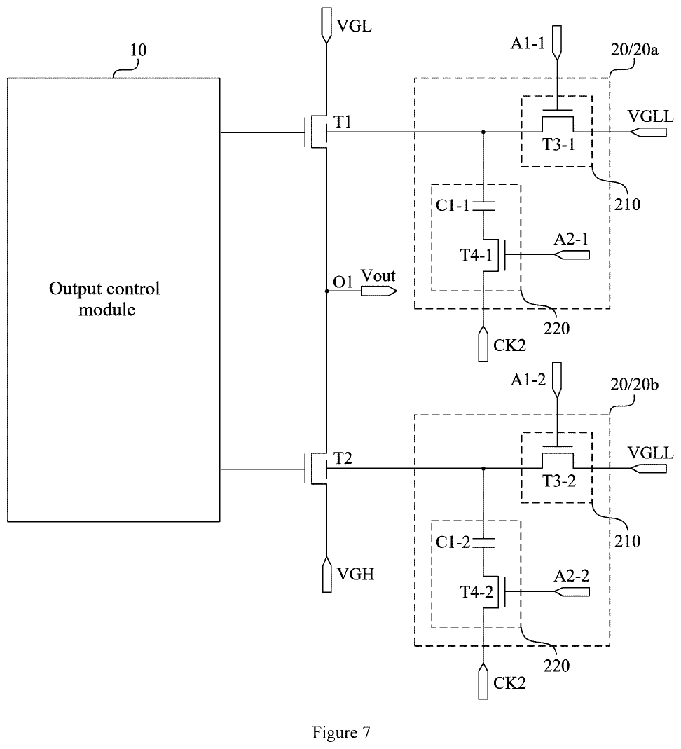

FIG. 7 is a schematic diagram of a structure of another gate drive circuit according to an embodiment of the present application. Referring to FIG. 7, based on the above embodiment, optionally, the first voltage regulation unit 210 includes a third transistor, and the second voltage regulation unit 220 includes a fourth transistor. A gate of the third transistor is connected to the first control signal, a first electrode of the third transistor is connected to the first level signal VGLL, and a second electrode of the third transistor is connected to the second gate of the dual-gate transistor. A gate of the fourth transistor is connected to the second control signal, and a first electrode of the fourth transistor is connected to the preset signal. The fourth transistor is configured to transmit a signal related to the preset signal to the second gate of the dual-gate transistor in response to the second control signal.

When the first transistor T1 is a dual-gate transistor, it may be configured that the first voltage regulation module 20a is connected to the second gate of the first transistor T1. In the first voltage regulation module 20a, a gate of the third transistor T3-1 is connected to the first control signal A1-1, a first electrode of the third transistor T3-1 is connected to the first level signal VGLL, and a second electrode of the third transistor T3-1 is connected to the second gate of the first transistor T1. A gate of the fourth transistor T4-1 is connected to the second control signal A2-1, and a first electrode of the fourth transistor T4-1 is connected to the preset signal. The fourth transistor T4-1 is configured to transmit a signal related to the preset signal to the second gate of the first transistor T1 in response to the second control signal A2-1. When the second transistor T2 is a dual-gate transistor, it may be configured that the second voltage regulation module 20b is connected to the second gate of the second transistor T2. In the second voltage regulation module 20b, a gate of the third transistor T3-2 is connected to the first control signal A1-2, a first electrode of the third transistor T3-2 is connected to the first level signal VGLL, and a second electrode of the third transistor T3-2 is connected to the second gate of the second transistor T2. A gate of the fourth transistor T4-2 is connected to the second control signal A2-2, and a first electrode of the fourth transistor T4-2 is connected to the preset signal. The fourth transistor T4-2 is configured to transmit a signal related to the preset signal to the second gate of the second transistor T2 in response to the second control signal A2-2.

Still referring to FIG. 7, in an embodiment, the second voltage regulation unit 220 further includes a first capacitor. The first capacitor is connected between a second electrode of the fourth transistor and the second gate of the dual-gate transistor. For example, when the first transistor T1 is a dual-gate transistor, the first voltage regulation module 20a may further include a first capacitor C1-1. The first capacitor C1-1 is connected between the second electrode of the fourth transistor T4-1 and the second gate of the first transistor T1. The preset signal connected to the first electrode of the fourth transistor T4-1 may be a clock signal, for example, a second clock signal CK2. When the second transistor T2 is a dual-gate transistor, the second voltage regulation module 20b may further include a first capacitor C1-2. The first capacitor C1-2 is connected between the second electrode of the fourth transistor T4-2 and the second gate of the second transistor T2. The preset signal connected to the first electrode of the fourth transistor T4-2 may also be a clock signal, for example, a second clock signal CK2.

In another embodiment, when no first capacitor C1-1 is disposed in the first voltage regulation module 20a, and the second electrode of the fourth transistor T4-1 is directly connected to the second gate of the first transistor T1, the preset signal connected to the first electrode of the fourth transistor T4-1 may be a second level signal VGH. Similarly, when no first capacitor C1-2 is disposed in the second voltage regulation module 20b, and the second electrode of the fourth transistor T4-2 is directly connected to the second gate of the second transistor T2, the preset signal connected to the first electrode of the fourth transistor T4-2 may also be a second level signal VGH.

Based on the plurality of embodiments described above, optionally, a level of the first level signal VGLL includes a first level, a level of the preset signal includes a second level, one of the first level and the second level is a preset high level, and the other of the first level and the second level is a preset low level. The preset high level is a high level opposite to the preset low level. A voltage corresponding to the preset high level may be a voltage corresponding to a high level for normally controlling a transistor to be conducted or cut off. For example, the voltage corresponding to the preset high level may be a voltage of about 3.5 V to 5 V. A voltage corresponding to the preset low level may be a voltage corresponding to a low level for normally controlling a transistor to be conducted or cut off. For example, the voltage corresponding to the preset low level may be a voltage of about −5 V to −7 V.

When a dual-gate transistor as the first transistor T1 and the second transistor T2 is an N-type transistor, the first level included in the first level signal VGLL is a preset low level, and the second level included in the preset signal is a preset high level. An example in which the first transistor T1 is a dual-gate transistor, and the first transistor T1 is an N-type transistor is used for description. When the first transistor T1 is cut off, the voltage of the second gate of the first transistor T1 can be reduced by transmitting the first level signal VGLL to the second gate of the first transistor T1, that is, transmitting a preset low level signal, to make the threshold voltage of the first transistor T1 tend to be positive, thereby helping ensure that the first transistor T1 is completely cut off, to suppress the leakage current of the first transistor T1. The second level signal VGH or the second clock signal CK2 in the above embodiments may both be used as the preset signal. When the first transistor T1 is conducted, the voltage of the second gate of the first transistor T1 is regulated through a preset high level in the second level signal VGH or the second clock signal CK2. In this way, the voltage of the second gate of the first transistor T1 can be raised, to make the threshold voltage of the first transistor T1 tend to be negative. When the voltage of the first gate of the first transistor T1 remains unchanged, a more negative threshold voltage of the first transistor T1 indicates a larger current of the first transistor T1. Therefore, the driving capability of the first transistor T1 can be improved.

When a dual-gate transistor as the first transistor T1 and the second transistor T2 is a P-type transistor, the first level included in the first level signal VGLL is a preset high level, and the second level included in the preset signal is a preset low level. The principle is the same as that described above. Details are not described again.

In FIG. 1 to FIG. 7, a case in which the first transistor T1 and the second transistor T2 are both dual-gate transistors, and the voltage regulation module 20 includes the first voltage regulation module 20a and the second voltage regulation module 20b is used as an example for illustration. In another embodiment, when either of the first transistor T1 and the second transistor T2 is a dual-gate transistor, only the voltage regulation module 20 correspondingly connected to the dual-gate transistor may be disposed. When the first transistor T1 and the second transistor T2 are both dual-gate transistors, only the voltage regulation module 20 correspondingly connected to one of the dual-gate transistors may alternatively be disposed.

FIG. 4, FIG. 5, and FIG. 7 all show a case in which the voltage regulation module 20 includes the first capacitor (i.e., C1-1 or C1-2), and the first capacitor is connected between the second electrode of the fourth transistor and the second gate of the corresponding dual-gate transistor. In another embodiment, it may alternatively be configured that the voltage regulation module 20 does not include the first capacitor, the first electrode of the fourth transistor is connected to the second clock signal CK2, and the second electrode of the fourth transistor is directly connected to the second gate of the corresponding dual-gate transistor. For example, referring to FIG. 7, the first capacitor C1-1 in the voltage regulation module 20 may be removed, so that the first electrode of the fourth transistor T4-1 is connected to the second clock signal CK2, and the second electrode of the fourth transistor T4-1 is directly connected to the second gate of the first transistor T1. In this way, when the first transistor T1 is an N-type transistor, the fourth transistor T4-1 may be controlled to transmit the preset high level in the second clock signal CK2 to the second gate of the first transistor T1 when the first transistor T1 is conducted, to raise the voltage of the second gate of the first transistor T1 and in turn make the threshold voltage of the first transistor T1 tend to be negative, thereby improving the driving capability of the first transistor T1. Similarly, the first capacitor C1-2 in the voltage regulation module 20 may also be removed, so that the first electrode of the fourth transistor T4-2 is connected to the second clock signal CK2, and the second electrode of the fourth transistor T4-2 is directly connected to the second gate of the second transistor T2.

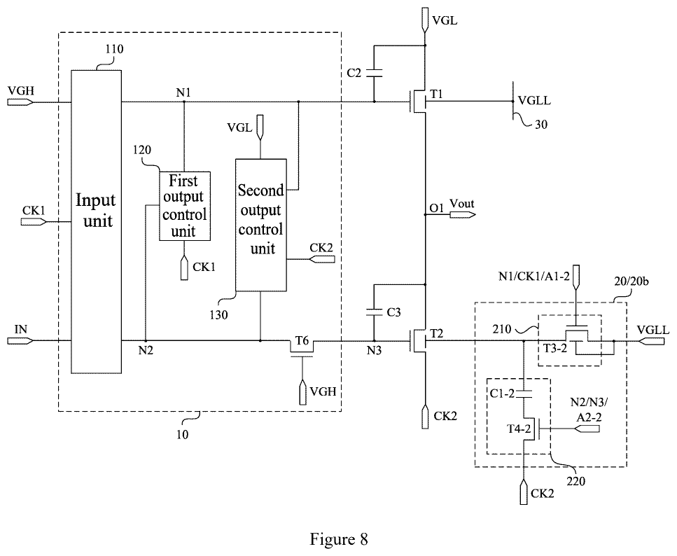

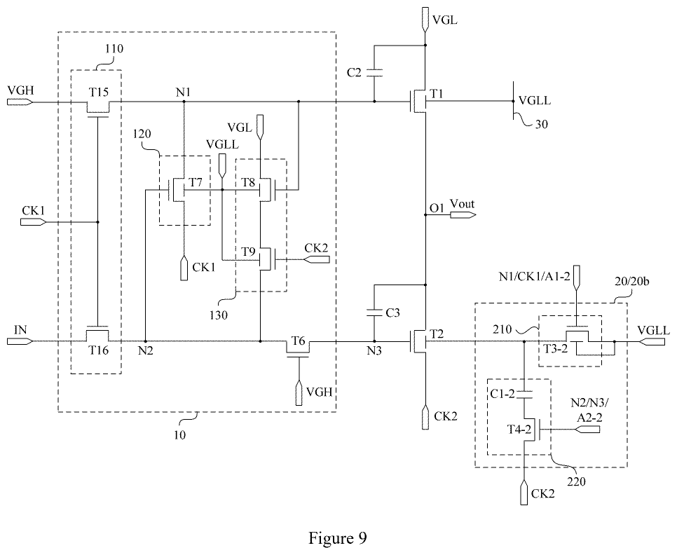

FIG. 8 is a schematic diagram of a structure of another gate drive circuit according to an embodiment of the present application. FIG. 9 is a schematic diagram of a structure of another gate drive circuit according to an embodiment of the present application. Referring to FIG. 8 and FIG. 9, optionally, a third transistor in a voltage regulation module 20 may also be a dual-gate transistor. In an embodiment, it may be configured that a first gate of the third transistor is connected to a first control signal, and a second gate of the third transistor is connected to a first level signal VGLL.

For example, when a second transistor T2 is a dual-gate transistor, a third transistor T3-2 in a second voltage regulation module 20b may be a dual-gate transistor. A first gate of the third transistor T3-2 is connected to a first control signal A1-2, and a second gate of the third transistor T3-2 is connected to a first electrode of the third transistor T3-2 to be connected to the first level signal VGLL. When a second transistor T2 is an N-type transistor, a first level included in the first level signal VGLL is a preset low level. When an output control module 10 controls the second transistor T2 to be conducted, a fourth transistor T4-2 is conducted in response to a second control signal A2-2, to transmit a second clock signal CK2 to a first capacitor C1-2 through the fourth transistor T4-2, so that the first capacitor C1-2 couples a potential of the second gate of the second transistor T2 when a level of the second clock signal CK2 jumps from a low level to a high level, to raise a voltage of the second gate of the second transistor T2 and in turn make a threshold voltage of the second transistor T2 tend to be negative, thereby improving a driving capability of the second transistor T2. Because the voltage of the second gate of the second transistor T2 is high, and a voltage of the first level signal VGLL is low, there is a voltage difference between two ends of the third transistor T3-2. The second gate of the third transistor T3-2 is connected to the first level signal VGLL, so that a potential of the second gate of the third transistor T3-2 is low, to help make a threshold voltage of the third transistor T3-2 tend to be positive, and ensure that the third transistor T3-2 is in a cut-off state when a voltage of the first gate of the third transistor T3-2 remains unchanged. This avoids a case in which the third transistor T3-2 is not in a completely cut-off state, resulting in a large leakage current and consequently affecting the voltage of the second gate of the second transistor T2, thereby not affecting the driving capability of the second transistor T2.

Similarly, when a first transistor T1 is a dual-gate transistor, and the voltage regulation module 20 includes a first voltage regulation module 20a corresponding to the first transistor T1, it may alternatively be configured that a third transistor in the first voltage regulation module 20a is a dual-gate transistor, a first gate of the third transistor is connected to the first control signal, and a second gate of the third transistor is connected to a first electrode of the third transistor, so that the second gate of the third transistor is connected to the first level signal VGLL.

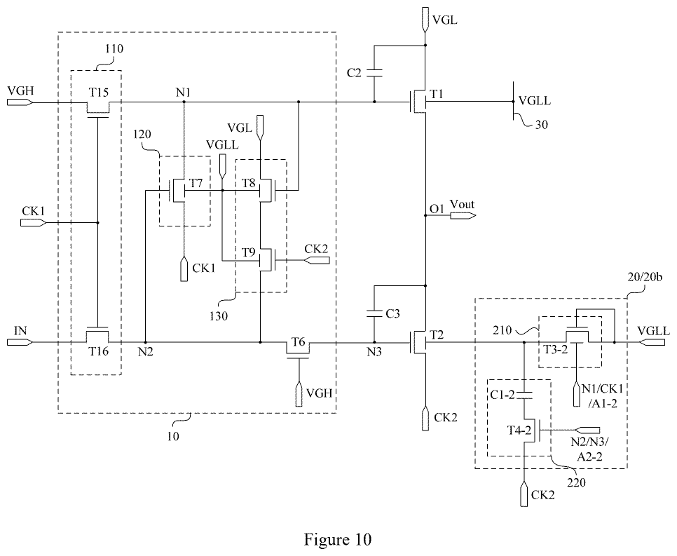

FIG. 10 is a schematic diagram of a structure of another gate drive circuit according to an embodiment of the present application. Referring to FIG. 10, optionally, in another embodiment, when a third transistor in a voltage regulation module 20 is a dual-gate transistor, it may alternatively be configured that a second gate of the third transistor is connected to a first control signal, and a first gate of the third transistor is connected to a first electrode of the third transistor.

For example, when a second transistor T2 is a dual-gate transistor, a third transistor T3-2 in a second voltage regulation module 20b may be a dual-gate transistor. A second gate of the third transistor T3-2 is connected to a first control signal A1-2, and a first gate of the third transistor T3-2 is connected to a first electrode of the third transistor T3-2 to be connected to a first level signal VGLL. An example in which the second transistor T2 is an N-type transistor, and a first level included in the first level signal VGLL is a preset low level is still used for description. As described in the above embodiment, when the output control module 10 controls the second transistor T2 to be conducted, in order to improve the driving capability of the second transistor T2, the voltage of the second gate of the second transistor T2 needs to be raised, and then there is a voltage difference between two ends of the third transistor T3-2. The first gate of the third transistor T3-2 is connected to the first level signal VGLL, so that the threshold voltage of the third transistor T3-2 can tend to be positive, and it can be ensured that the third transistor T3-2 is in a cut-off state when a voltage of the second gate of the third transistor T3-2 remains unchanged. This avoids a case in which the third transistor T3-2 is not in a completely cut-off state, resulting in a large leakage current and consequently affecting the voltage of the second gate of the second transistor T2, thereby not affecting the driving capability of the second transistor T2. In addition, because the second gate of the third transistor T3-2 is connected to the first control signal A1-2, the third transistor T3-2 may also be controlled to be conducted or cut off by controlling the voltage of the second gate of the third transistor T3-2, so that the third transistor T3-2 can still be conducted in response to the first control signal A1-2 when the second transistor T2 is cut off, to transmit the first level signal VGLL to the second gate of the second transistor T2 through the third transistor T3-2. The voltage of the second gate of the second transistor T2 is regulated through the first level signal VGLL, to regulate the threshold voltage of the second transistor T2, thereby helping ensure that the second transistor T2 is completely cut off, to suppress a leakage current of the second transistor T2.

Similarly, when a first transistor T1 is a dual-gate transistor, and the voltage regulation module 20 includes a first voltage regulation module 20a corresponding to the first transistor T1, it may alternatively be configured that a third transistor in the first voltage regulation module 20a is a dual-gate transistor, a second gate of the third transistor is connected to the first control signal, and a first gate of the third transistor is connected to a first electrode of the third transistor to be connected to a first level signal VGLL.

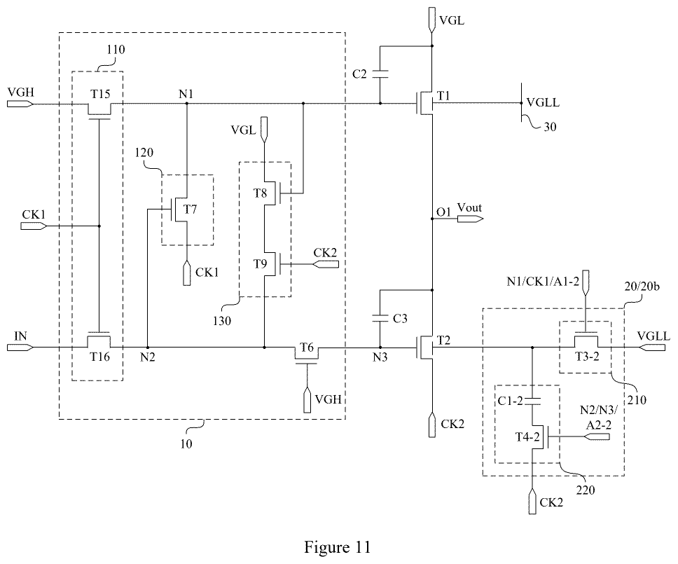

FIG. 11 is a schematic diagram of a structure of another gate drive circuit according to an embodiment of the present application. Referring to FIG. 8 to FIG. 11, when a first transistor T1 and a second transistor T2 are both dual-gate transistors, it may alternatively be configured that a second gate of one of the first transistor T1 and the second transistor T2 is connected to a first level signal line 30, the first level signal line 30 is connected to a first level signal VGLL, and a second gate of the other of the first transistor T1 and the second transistor T2 is connected to a voltage regulation module 20.

For example, the second gate of the first transistor T1 is connected to the first level signal line 30, and the second gate of the second transistor T2 is connected to the voltage regulation module 20. When the first transistor T1 and the second transistor T2 are both N-type transistors, a first level included in the first level signal VGLL is a preset low level. The first level signal VGLL may be transmitted to the second gate of the first transistor T1 through the first level signal line 30, to reduce a voltage of the second gate of the first transistor T1. This helps avoid a leakage current problem caused by impossibility to completely cut off the first transistor T1, to suppress a leakage current of the first transistor T1. A third transistor T3-2 in the voltage regulation module 20 may transmit the first level signal VGLL to the second gate of the second transistor T2 when the second transistor T2 is cut off, thereby helping ensure that the second transistor T2 is completely cut off, to suppress a leakage current of the second transistor T2. A fourth transistor T4-2 may transmit a second clock signal CK2 to a first capacitor C1-2 when the second transistor T2 is conducted, to raise a voltage of the second gate of the second transistor T2 through a coupling function of the first capacitor C1-2 and in turn make a threshold voltage of the second transistor T2 tend to be negative, thereby improving a driving capability of the second transistor T2.

When the first transistor T1 and the second transistor T2 are both P-type transistors, the first level included in the first level signal VGLL is a preset high level. Transmitting the first level signal VGLL to the second gate of the first transistor T1 through the first level signal line 30 also helps suppress the leakage current of the first transistor T1. In addition, disposing the voltage regulation module 20 also helps suppress the leakage current of the second transistor T2 when the second transistor T2 is cut off, and improve the driving capability of the second transistor T2 when the second transistor T2 is conducted.

In another embodiment, when the first transistor T1 and the second transistor T2 are both dual-gate transistors, it may be configured that a first gate and a second gate of one of the first transistor T1 and the second transistor T2 are connected, and a second gate of the other of the first transistor T1 and the second transistor T2 is connected to the voltage regulation module 20.

For example, a first gate and a second gate of the first transistor T1 are connected, and a second gate of the second transistor T2 is connected to the voltage regulation module 20. In a case in which the first transistor T1 is an N-type transistor, when an output control module 10 transmits a high level signal to the first gate and the second gate of the first transistor T1, levels of the first gate and the second gate of the first transistor T1 are both high levels, to control the first transistor T1 to be conducted. The first gate and the second gate of the first transistor T1 are connected, so that a gate control capability of the first transistor T1 can be improved, thereby improving a driving capability of the first transistor T1. When the output control module 10 transmits a low level signal to the first gate and the second gate of the first transistor T1, the levels of the first gate and the second gate of the first transistor T1 are both low levels, to control the first transistor T1 to be cut off. The first gate and the second gate of the first transistor T1 are connected, so that the gate control capability of the first transistor T1 can be improved, thereby helping ensure that the first transistor T1 is completely cut off, to suppress the leakage current of the first transistor T1. Similarly, in a case in which the first transistor T1 is a P-type transistor, when the output control module 10 transmits a low level signal to the first gate and the second gate of the first transistor T1, the first transistor T1 may be controlled to be conducted, and the driving capability of the first transistor T1 is improved. When the output control module 10 transmits a high level signal to the first gate and the second gate of the first transistor T1, the first transistor T1 may be controlled to be cut off, and the leakage current of the first transistor T1 is suppressed. Disposing the voltage regulation module 20 helps suppress the leakage current of the second transistor T2 when the second transistor T2 is cut off, and improve the driving capability of the second transistor T2 when the second transistor T2 is conducted.

In the embodiments of the present application, there may be a plurality of types of structures of the output control module in the gate drive circuit, and a plurality of types of gate drive circuits may be formed based on different structures such as a structure of the voltage regulation module described in the plurality of embodiments described above. The following uses several of these as examples for description.

Referring to FIG. 8, in an embodiment, the output control module 10 in the gate drive circuit may include: an input unit 110, a first output control unit 120, and a second output control unit 130. The input unit 110 is connected to a first node N1, a second node N2, and an input terminal of the gate drive circuit, and is configured to control a signal at the first node N1 and a signal at the second node N2 based on a first clock signal CK1, a second level signal VGH, and a signal at the input terminal of the gate drive circuit, namely a start signal IN. The first output control unit 120 is connected to the first node N1 and the second node N2, and is configured to control the signal at the first node N1 based on the signal at the second node N2 and the first clock signal CK1. The second output control unit 130 is connected to the first node N1 and the second node N2, and is configured to control the signal at the second node N2 based on the signal at the first node N1, a second clock signal CK2, and a third level signal VGL. The first node N1 is connected to the gate of the first transistor T1, and the signal at the second node N2 is transmitted to the gate of the second transistor T2. The third level signal VGL is reused as a first output signal, and the second clock signal CK2 is reused as a second output signal.

One of the second level signal VGH and the third level signal VGL is a high level signal, and the other of the second level signal VGH and the third level signal VGL is a low level signal. The input terminal of the gate drive circuit is connected to the start signal IN. The input unit 110 controls the signal at the first node N1 and the signal at the second node N2 based on the first clock signal CK1, the second level signal VGH, and the signal at the input terminal of the gate drive circuit, which may mean that the input unit 110 transmits the second level signal VGH to the first node N1 in response to the first clock signal CK1, and transmits the start signal IN to the second node N2 in response to the first clock signal CK1. The first output control unit 120 controls the signal at the first node N1 based on the signal at the second node N2 and the first clock signal CK1, which means that the first output control unit 120 may transmit the first clock signal CK1 to the first node N1 in response to the signal at the second node N2. The second output control unit 130 controls the signal at the second node N2 based on the signal at the first node N1, the second clock signal CK2, and the third level signal VGL, which means that the second output control unit 130 may transmit the third level signal VGL to the second node N2 in response to the signal at the first node N1 and the second clock signal CK2.

When the third level signal VGL is a low level signal, the output control module 10 is configured to include the input unit 110, the first output control unit 120, and the second output control unit 130, so that the signal at the first node N1 and the signal at the second node N2 can be controlled, thereby controlling the first transistor T1 and the second transistor T2 to be alternately conducted. In this way, when the first transistor T1 is conducted, the first transistor T1 transmits the third level signal VGL to the output terminal O1 of the gate drive circuit, so that a gate drive signal output by the gate drive circuit is a low level signal; and when the second transistor T2 is conducted, the second transistor T2 transmits a high level signal in the second clock signal CK2 to the output terminal O1 of the gate drive circuit, so that a gate drive signal output by the gate drive circuit is a high level signal. Similarly, when the third level signal VGL is a high level signal, the output control module 10 is configured to include the input unit 110, the first output control unit 120, and the second output control unit 130, so that the signal at the first node N1 and the signal at the second node N2 can be controlled, thereby controlling the first transistor T1 and the second transistor T2 to be alternately conducted. In this way, when the first transistor T1 is conducted, the first transistor T1 transmits the third level signal VGL to the output terminal O1 of the gate drive circuit, so that a gate drive signal output by the gate drive circuit is a high level signal; and when the second transistor T2 is conducted, the second transistor T2 transmits a low level signal in the second clock signal CK2 to the output terminal O1 of the gate drive circuit, so that a gate drive signal output by the gate drive circuit is a low level signal.

Referring to FIG. 8 to FIG. 11, in an embodiment, it may be configured that the output control module 10 further includes a sixth transistor T6, the sixth transistor T6 is connected between a third node N3 and the second node N2, the sixth transistor T6 remains in a normally conducted state, and the third node N3 is connected to the gate of the second transistor T2, so that the signal at the second node N2 is transmitted to the gate of the second transistor T2 through the sixth transistor T6. In another embodiment, it may alternatively be configured that the second node N2 is directly connected to the gate of the second transistor T2, so that the signal at the second node N2 may be directly transmitted to the gate of the second transistor T2.

Referring to FIG. 9 to FIG. 11, based on the above embodiment, optionally, the first output control unit 120 includes a seventh transistor T7. A gate of the seventh transistor T7 is connected to the second node N2, a first electrode of the seventh transistor T7 is connected to the first clock signal CK1, and a second electrode of the seventh transistor T7 is connected to the first node N1. The second output control unit 130 includes an eighth transistor T8 and a ninth transistor T9. A gate of the eighth transistor T8 is connected to the first node N1, a first electrode of the eighth transistor T8 is connected to the third level signal VGL, and a second electrode of the eighth transistor T8 is connected to a first electrode of the ninth transistor T9. A gate of the ninth transistor T9 is connected to the second clock signal CK2, and a second electrode of the ninth transistor T9 is connected to the second node N2. The input unit 110 includes a fifteenth transistor T15 and a sixteenth transistor T16. A gate of the fifteenth transistor T15 and a gate of the sixteenth transistor T16 are both connected to the first clock signal CK1. A first electrode of the fifteenth transistor T15 is connected to the second level signal VGH, and a second electrode of the fifteenth transistor T15 is connected to the first node N1. A first electrode of the sixteenth transistor T16 may be connected to the start signal IN as the input terminal of the gate drive circuit, and a second electrode of the sixteenth transistor T16 is connected to the second node N2. The gate drive circuit further includes a second capacitor C2 and a third capacitor C3. The second capacitor C2 is connected between the first gate and the first electrode of the first transistor T1. The third capacitor C3 is connected between the first gate and the second electrode of the second transistor T2.

Referring to FIG. 9 and FIG. 10, optionally, the seventh transistor T7, the eighth transistor T8, and the ninth transistor T9 are all dual-gate transistors. A first gate of the seventh transistor T7 is connected to the second node N2. A first gate of the eighth transistor T8 is connected to the first node N1. A first gate of the ninth transistor T9 is connected to the second clock signal CK2. A second gate of the seventh transistor T7, a second gate of the eighth transistor T8, and a second gate of the ninth transistor T9 are all connected to the first level signal VGLL.

When the seventh transistor T7, the eighth transistor T8, and the ninth transistor T9 are all N-type transistors, the first level signal VGLL is a preset low level signal, and the second gate of the seventh transistor T7, the second gate of the eighth transistor T8, and the second gate of the ninth transistor T9 are all connected to the first level signal VGLL, so that a voltage of the second gate of the seventh transistor T7, a voltage of the second gate of the eighth transistor T8, and a voltage of the second gate of the ninth transistor T9 can be reduced, to make threshold voltages of the seventh transistor T7, the eighth transistor T8, and the ninth transistor T9 all tend to be positive. This helps avoid a leakage current problem caused by impossibility to completely cut off the seventh transistor T7, the eighth transistor T8, and the ninth transistor T9, to suppress leakage currents of the seventh transistor T7, the eighth transistor T8, and the ninth transistor T9, thereby avoiding affecting potentials of the first node N1, the second node N2, and the third node N3, and helping ensure that the first transistor T1 and the second transistor T2 operate normally.

FIG. 9 and FIG. 10 show a case in which the seventh transistor T7, the eighth transistor T8, and the ninth transistor T9 are all dual-gate transistors. In another embodiment, it may alternatively be configured that only the seventh transistor T7 is a dual-gate transistor, the first gate of the seventh transistor T7 is connected to the second node N2, and the second gate of the seventh transistor T7 is connected to the first level signal VGLL. A reason is that the seventh transistor T7 is in a cut-off state for a long time during operation of the gate drive circuit, which helps solve a leakage current problem caused by impossibility to completely cut off the seventh transistor T7, thereby avoiding affecting the potential of the first node N1, and helping ensure that the first transistor T1 operates normally. In another embodiment, it may alternatively be configured that only the eighth transistor T8 and the ninth transistor T9 are both dual-gate transistors, the first gate of the eighth transistor T8 is connected to the first node N1, the first gate of the ninth transistor T9 is connected to the second clock signal CK2, and the second gate of the eighth transistor T8 and the second gate of the ninth transistor T9 are both connected to the first level signal VGLL, to solve a leakage current problem caused by impossibility to completely cut off the eighth transistor T8 and the ninth transistor T9, thereby avoiding affecting the potentials of the second node N2 and the third node N3, and helping ensure that the second transistor T2 operates normally.

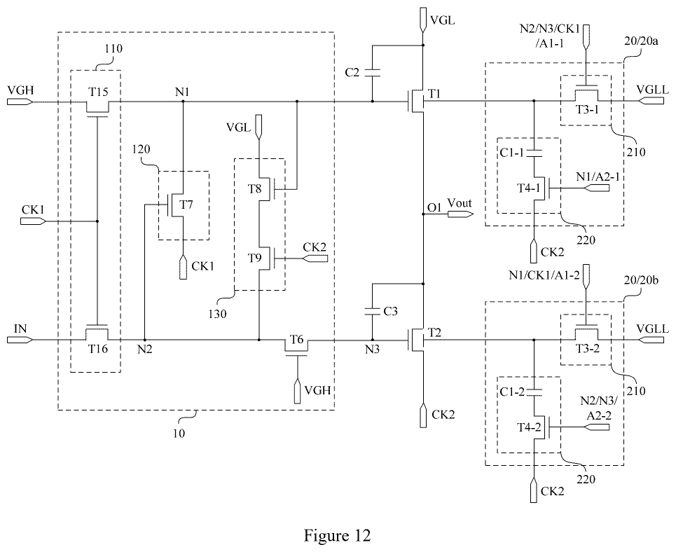

FIG. 12 is a schematic diagram of a structure of another gate drive circuit according to an embodiment of the present application. Referring to FIG. 12, optionally, when a first transistor T1 is a dual-gate transistor, a voltage regulation module 20 includes a first voltage regulation module 20a. When a second transistor T2 is a dual-gate transistor, the voltage regulation module 20 includes a second voltage regulation module 20b. A first output signal may be a fixed voltage signal, and a second output signal may be a second clock signal CK2. A polarity of the first output signal may be the same as a polarity of a first level signal VGLL. An absolute value of the first level signal VGLL is greater than or equal to an absolute value of the first output signal. A signal at a first gate of the second transistor T2, a signal synchronized with the signal at the first gate of the second transistor T2 in terms of changes in high levels and low levels, or a first clock signal CK1 may be reused as a first control signal A1-1 in the first voltage regulation module 20a. A signal at a second node N2, a signal at a third node N3, or the first clock signal CK1 is reused as the first control signal A1-1 in the first voltage regulation module 20a. A signal at a first gate of the first transistor T1 or a signal synchronized with the signal at the first gate of the first transistor T1 in terms of changes in high levels and low levels may be reused as a second control signal A2-1 in the first voltage regulation module 20a. A signal at a first node N1 is reused as the second control signal A2-1 in the first voltage regulation module 20a. The second clock signal CK2 or a second level signal VGH is reused as a preset signal in the first voltage regulation module 20a and the second voltage regulation module 20b. The signal at the first gate of the first transistor T1, the signal synchronized with the signal at the first gate of the first transistor T1 in terms of changes in high levels and low levels, or the first clock signal CK1 may be reused as a first control signal A1-2 in the second voltage regulation module 20b. The signal at the first node N1 or the first clock signal CK1 is reused as the first control signal A1-2 in the second voltage regulation module 20b. The signal at the first gate of the second transistor T2 or the signal synchronized with the signal at the first gate of the second transistor T2 in terms of changes in high levels and low levels may be reused as a second control signal A2-2 in the second voltage regulation module 20b. The signal at the second node N2 or the signal at the third node N3 is reused as the second control signal A2-2 in the second voltage regulation module 20b. A signal on a signal line connected to an output control module 10 or a signal at a node in the output control module 10 is reused as the first control signal and the second control signal, so that the number of signal lines introduced from an external chip can be reduced.

A plurality of transistors in the gate drive circuit may all be either N-type transistors or P-type transistors. For example, when a plurality of transistors in the gate drive circuit are all N-type transistors, the first level signal VGLL is a preset low level signal, the second level signal VGH is a preset high level signal, and a third level signal VGL is a low level signal. When the output control module 10 controls the first transistor T1 to be cut off and controls the second transistor T2 to be conducted, a high level signal in the second clock signal CK2 is transmitted to an output terminal O1 of the gate drive circuit through the second transistor T2, and a gate drive signal output by the gate drive circuit is a high level signal. The signal at the first node N1 is a low level signal, and the signal at the second node N2 and the signal at the third node N3 are high level signals. A third transistor T3-1 in the first voltage regulation module 20a is conducted in response to the signal at the second node N2, the signal at the third node N3, or a high level signal in the first clock signal CK1, to transmit the first level signal VGLL to a second gate of the first transistor T1 through the third transistor T3-1, so that a voltage of the second gate of the first transistor T1 can be reduced, to make a threshold voltage of the first transistor T1 tend to be positive. This helps ensure that the first transistor T1 is completely cut off, to suppress a leakage current of the first transistor T1, thereby reducing power consumption of the first transistor T1 caused by the leakage current, and solving the problem of waveform distortion of the gate drive signal.

When the output control module 10 controls the first transistor T1 to be conducted and controls the second transistor T2 to be cut off, the third level signal VGL is transmitted to the output terminal O1 of the gate drive circuit through the first transistor T1, and a gate drive signal output by the gate drive circuit is a low level signal. The signal at the first node N1 is a high level signal, and the signal at the second node N2 and the signal at the third node N3 are low level signals. A fourth transistor T4-1 in the first voltage regulation module 20a is conducted in response to the signal at the first node N1, to transmit the second clock signal CK2 to a first capacitor C1-1 through the fourth transistor T4-1, so that the first capacitor C1-1 couples a potential of the second gate of the first transistor T1 when a level of the second clock signal CK2 jumps from a low level to a high level. In this way, the voltage of the second gate of the first transistor T1 can be raised, to make the threshold voltage of the first transistor T1 tend to be negative, thereby improving a driving capability of the first transistor T1, and solving the problem of waveform distortion of the gate drive signal.

Similarly, a function of the second voltage regulation module 20b on the second transistor T2 is similar to a function of the first voltage regulation module 20a on the first transistor T1, which can be understood with reference to the above embodiments. Details are not described again. In addition, when a plurality of transistors in the gate drive circuit are all P-type transistors, it may be configured that the first level signal VGLL is a preset high level signal, the second level signal VGH is a preset low level signal, and the third level signal VGL is a high level signal. The principle is the same as that described above.

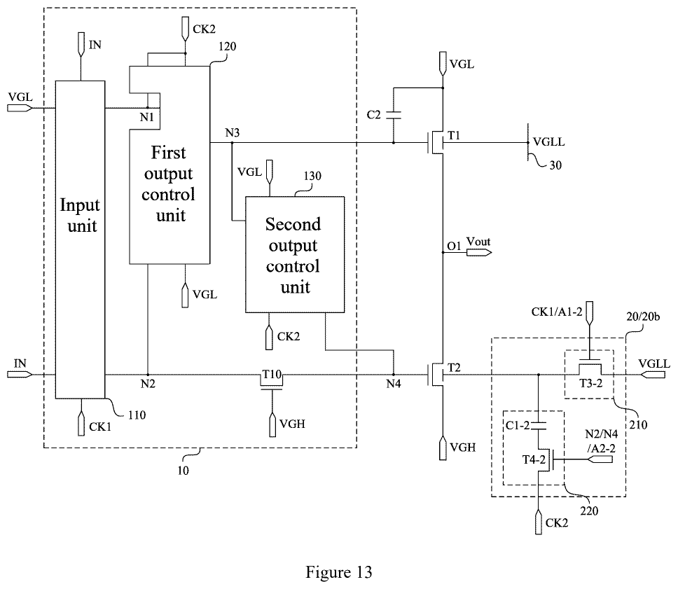

FIG. 13 is a schematic diagram of a structure of another gate drive circuit according to an embodiment of the present application. Referring to FIG. 13, in another embodiment, an output control module 10 in the gate drive circuit may include: an input unit 110, a first output control unit 120, and a second output control unit 130. The input unit 110 is connected to a first node N1, a second node N2, and an input terminal of the gate drive circuit, and is configured to control a signal at the first node N1 and a signal at the second node N2 based on a first clock signal CK1, a third level signal VGL, and a signal at the input terminal of the gate drive circuit, namely a start signal IN. The first output control unit 120 is connected to a third node N3, the first node N1, and the second node N2, and is configured to control a signal at the third node N3 based on a second clock signal CK2, the signal at the first node N1, the signal at the second node N2, and the third level signal VGL. The third node N3 is connected to a gate of a first transistor T1. The second output control unit 130 is connected to a fourth node N4 and the third node N3, and is configured to control a signal at the fourth node N4 based on the signal at the third node N3, the signal at the fourth node N4, the third level signal VGL, and the second clock signal CK2. The fourth node N4 is connected to a gate of a second transistor T2, and the signal at the second node N2 is transmitted to the gate of the second transistor T2. The third level signal VGL is reused as a first output signal, and a second level signal VGH is reused as a second output signal.

One of the second level signal VGH and the third level signal VGL is a high level signal, and the other of the second level signal VGH and the third level signal VGL is a low level signal. The input terminal of the gate drive circuit is connected to the start signal IN. The input unit 110 controls the signal at the first node N1 and the signal at the second node N2 based on the first clock signal CK1, the third level signal VGL, and the signal at the input terminal of the gate drive circuit, which may mean that the input unit 110 transmits the third level signal VGL to the first node N1 in response to the start signal IN, and transmits the start signal IN to the second node N2 in response to the first clock signal CK1. The first output control unit 120 controls the signal at the third node N3 based on the second clock signal CK2, the signal at the first node N1, the signal at the second node N2, and the third level signal VGL, which means that the first output control unit 120 may transmit the second clock signal CK2 to the third node N3 in response to the signal at the first node N1, and transmit the third level signal VGL to the third node N3 in response to the signal at the second node N2. The second output control unit 130 controls the signal at the fourth node N4 based on the signal at the third node N3, the signal at the fourth node N4, the third level signal VGL, and the second clock signal CK2, which means that the second output control unit 130 may control, through the third level signal VGL and the second clock signal CK2, the signal at the fourth node N4 in response to the signal at the third node N3 and the signal at the fourth node N4.

The output control module 10 is configured to include the input unit 110, the first output control unit 120, and the second output control unit 130, so that the signals at the first node N1, the second node N2, the third node N3, and the fourth node N4 can be controlled, thereby controlling the first transistor T1 and the second transistor T2 to be alternately conducted. In this way, when the first transistor T1 is conducted, the first transistor T1 transmits the third level signal VGL to an output terminal O1 of the gate drive circuit; and when the second transistor T2 is conducted, the second transistor T2 transmits the second level signal VGH to the output terminal O1 of the gate drive circuit, so that the gate drive circuit outputs a gate drive signal with alternate high levels and low levels.

Still referring to FIG. 13, based on the above embodiment, optionally, the output control module 10 further includes a tenth transistor T10. The tenth transistor T10 is connected between the second node N2 and the fourth node N4. The tenth transistor T10 remains in a normally conducted state, to transmit the signal at the second node N2 to the gate of the second transistor T2 through the tenth transistor T10. In another embodiment, it may alternatively be configured that the second node N2 is directly connected to the gate of the second transistor T2, so that the signal at the second node N2 may be directly transmitted to the gate of the second transistor T2.

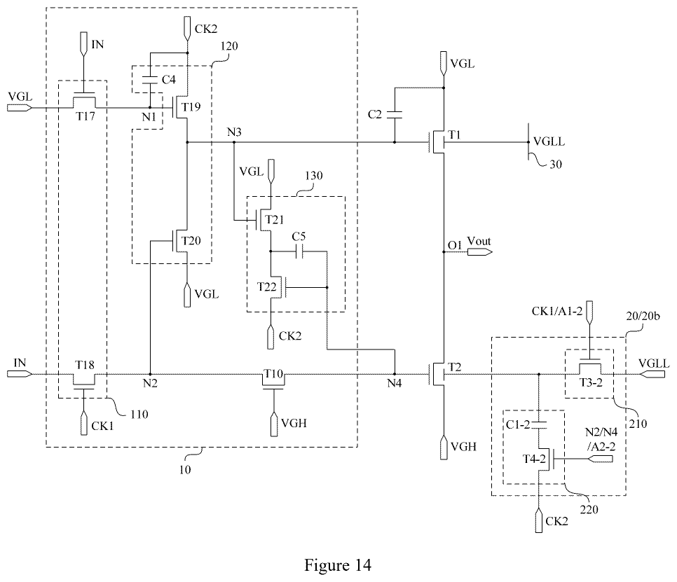

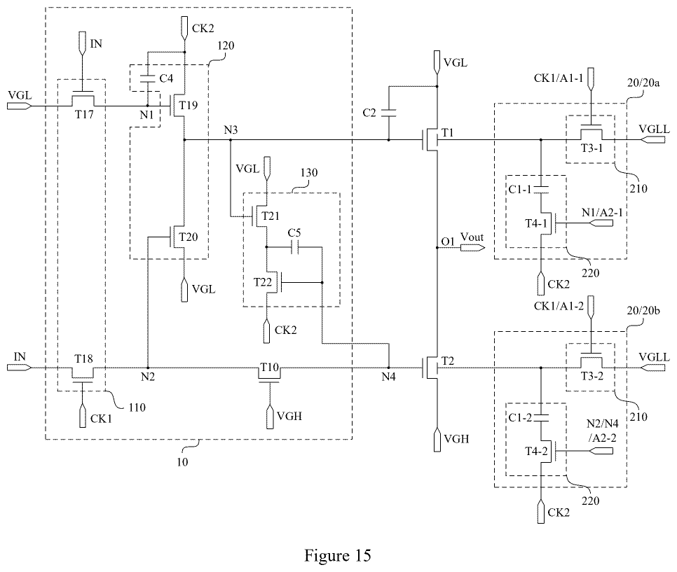

FIG. 14 is a schematic diagram of a structure of another gate drive circuit according to an embodiment of the present application. FIG. 15 is a schematic diagram of a structure of another gate drive circuit according to an embodiment of the present application. Referring to FIG. 14 and FIG. 15, based on the above embodiment, optionally, the input unit 110 includes a seventeenth transistor T17 and an eighteenth transistor T18. A gate of the seventeenth transistor T17 and a first electrode of the eighteenth transistor T18 are connected to the start signal IN as the input terminal of the gate drive circuit. A first electrode of the seventeenth transistor T17 is connected to the third level signal VGL, and a second electrode of the seventeenth transistor T17 is connected to the first node N1. A gate of the eighteenth transistor T18 is connected to the first clock signal CK1, and a second electrode of the eighteenth transistor T18 is connected to the second node N2. The first output control unit 120 includes a nineteenth transistor T19, a twentieth transistor T20, and a fourth capacitor C4. A gate of the nineteenth transistor T19 is connected to the first node N1, a first electrode of the nineteenth transistor T19 is connected to the second clock signal CK2, and a second electrode of the nineteenth transistor T19 is connected to the third node N3. A gate of the twentieth transistor T20 is connected to the second node N2, a first electrode of the twentieth transistor T20 is connected to the third level signal VGL, and a second electrode of the twentieth transistor T20 is connected to the third node N3. The fourth capacitor C4 is connected between the gate and the first electrode of the nineteenth transistor T19. The second output control unit 130 includes a twenty-first transistor T21, a twenty-second transistor T22, and a fifth capacitor C5. A gate of the twenty-first transistor T21 is connected to the third node N3, and a first electrode of the twenty-first transistor T21 is connected to the third level signal VGL. A gate of the twenty-second transistor T22 is connected to the fourth node N4, a first electrode of the twenty-second transistor T22 is connected to the second clock signal CK2, and a second electrode of the twenty-second transistor T22 is connected to a second electrode of the twenty-first transistor T21. The fifth capacitor C5 is connected between the gate and the second electrode of the twenty-second transistor T22.

Referring to FIG. 15, optionally, when the first transistor T1 is a dual-gate transistor, a voltage regulation module 20 includes a first voltage regulation module 20a. When the second transistor T2 is a dual-gate transistor, the voltage regulation module 20 includes a second voltage regulation module 20b. The first clock signal CK1 is reused as a first control signal A1-1 in the first voltage regulation module 20a and a first control signal A1-2 in the second voltage regulation module 20b. The signal at the first node N1 is reused as a second control signal A2-1 in the first voltage regulation module 20a. The second clock signal CK2 or the second level signal VGH is reused as a preset signal in the first voltage regulation module 20a and the second voltage regulation module 20b. The signal at the second node N2 or the signal at the fourth node N4 is reused as a second control signal A2-2 in the second voltage regulation module 20b.

A plurality of transistors in the gate drive circuit may all be either N-type transistors or P-type transistors. For example, when a plurality of transistors in the gate drive circuit are all N-type transistors, the first level signal VGLL is a preset low level signal, the second level signal VGH is a preset high level signal, and the third level signal VGL is a low level signal. When the output control module 10 controls the first transistor T1 to be cut off and controls the second transistor T2 to be conducted, the second level signal VGH is transmitted to the output terminal O1 of the gate drive circuit through the second transistor T2, and a gate drive signal output by the gate drive circuit is a high level signal. The signal at the second node N2 and the signal at the fourth node N4 are high level signals, and a fourth transistor T4-2 in the second voltage regulation module 20b is conducted in response to the signal at the second node N2 or the signal at the fourth node N4, to transmit the second clock signal CK2 to a first capacitor C1-2 through the fourth transistor T4-2, so that the first capacitor C1-2 couples a potential of a second gate of the second transistor T2 when a level of the second clock signal CK2 jumps from a low level to a high level. In this way, a voltage of the second gate of the second transistor T2 can be raised, to make a threshold voltage of the second transistor T2 tend to be negative, thereby improving a driving capability of the second transistor T2, and solving the problem of waveform distortion of the gate drive signal.

When the output control module 10 controls the first transistor T1 to be conducted and controls the second transistor T2 to be cut off, the third level signal VGL is transmitted to the output terminal O1 of the gate drive circuit through the first transistor T1, and a gate drive signal output by the gate drive circuit is a low level signal. The signal at the second node N2 and the signal at the fourth node N4 are low level signals, and a third transistor T3-2 in the second voltage regulation module 20b is conducted in response to a high level signal in the first clock signal CK1, to transmit the first level signal VGLL to the gate of the second transistor T2 through the third transistor T3-2, so that a voltage of the second gate of the second transistor T2 can be reduced, to make a threshold voltage of the second transistor T2 tend to be positive. This helps ensure that the second transistor T2 is completely cut off, to suppress a leakage current of the second transistor T2, thereby reducing power consumption of the second transistor T2 caused by the leakage current, and solving the problem of waveform distortion of the gate drive signal.

Similarly, a function of the first voltage regulation module 20a on the first transistor T1 is similar to a function of the second voltage regulation module 20b on the second transistor T2, which can be understood with reference to the above embodiments. Details are not described again. In addition, when a plurality of transistors in the gate drive circuit are all P-type transistors, it may be configured that the first level signal VGLL is a preset high level signal, the second level signal VGH is a preset low level signal, and the third level signal VGL is a high level signal. The principle is the same as that described above.

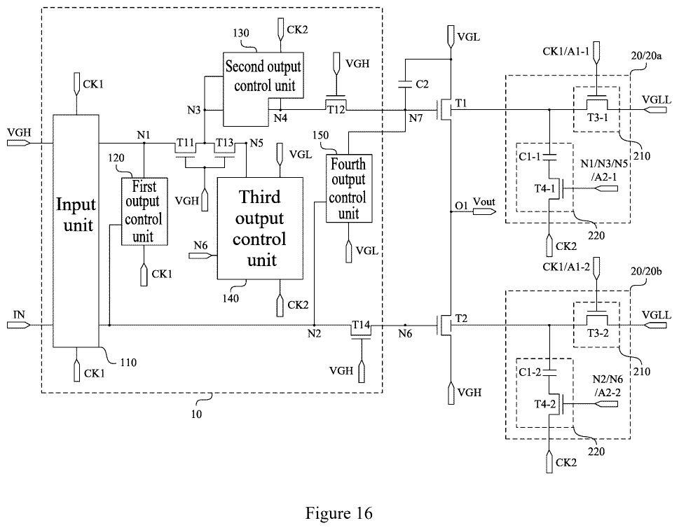

FIG. 16 is a schematic diagram of a structure of another gate drive circuit according to an embodiment of the present application. Referring to FIG. 16, in another embodiment, an output control module 10 in the gate drive circuit may include: an input unit 110, a first output control unit 120, a second output control unit 130, a third output control unit 140, and a fourth output control unit 150. The input unit 110 is connected to a first node N1, a second node N2, and an input terminal of the gate drive circuit, and is configured to control a signal at the first node N1 and a signal at the second node N2 based on a first clock signal CK1, a second level signal VGH, and a signal at the input terminal of the gate drive circuit, namely a start signal IN. The first output control unit 120 is connected to the first node N1 and the second node N2, and is configured to control the signal at the first node N1 based on the signal at the second node N2 and the first clock signal CK1. The second output control unit 130 is connected to a third node N3 and a fourth node N4, and is configured to control a signal at the fourth node N4 based on a signal at the third node N3 and a second clock signal CK2. The signal at the first node N1 is transmitted to the third node N3, and the signal at the fourth node N4 is transmitted to a gate of a first transistor T1. The third output control unit 140 is connected to a fifth node N5 and a sixth node N6, and is configured to control a signal at the sixth node N6 based on a signal at the fifth node N5, the signal at the sixth node N6, a third level signal VGL, and the second clock signal CK2. The signal at the first node N1 is transmitted to the fifth node N5, the signal at the second node N2 is transmitted to the sixth node N6, and the sixth node N6 is connected to a gate of a second transistor T2. The fourth output control unit 150 is connected to a seventh node N7 and the second node N2, and is configured to control a signal at the seventh node N7 based on the signal at the second node N2 and the third level signal VGL. The signal at the fourth node N4 is transmitted to the seventh node N7, and the seventh node N7 is connected to the gate of the first transistor T1. The third level signal VGL is reused as a first output signal, and the second level signal VGH is reused as a second output signal.

One of the second level signal VGH and the third level signal VGL is a high level signal, and the other of the second level signal VGH and the third level signal VGL is a low level signal. The input terminal of the gate drive circuit is connected to the start signal IN. The input unit 110 controls the signal at the first node N1 and the signal at the second node N2 based on the first clock signal CK1, the second level signal VGH, and the signal at the input terminal of the gate drive circuit, which may mean that the input unit 110 transmits the second level signal VGH to the first node N1 in response to the first clock signal CK1, and transmits the start signal IN to the second node N2 in response to the first clock signal CK1. The first output control unit 120 controls the signal at the first node N1 based on the signal at the second node N2 and the first clock signal CK1, which means that the first output control unit 120 may transmit the first clock signal CK1 to the first node N1 in response to the signal at the second node N2. The second output control unit 130 controls the signal at the fourth node N4 based on the signal at the third node N3 and the second clock signal CK2, which means that the second output control unit 130 may control, through the second clock signal CK2, the signal at the fourth node N4 in response to the signal at the third node N3 and the signal at the fourth node N4. The third output control unit 140 controls the signal at the sixth node N6 based on the signal at the fifth node N5, the signal at the sixth node N6, the third level signal VGL, and the second clock signal CK2, which means that the third output control unit 140 may control, through the third level signal VGL and the second clock signal CK2, the signal at the sixth node N6 in response to the signal at the fifth node N5 and the signal at the sixth node N6. The fourth output control unit 150 controls the signal at the seventh node N7 based on the signal at the second node N2 and the third level signal VGL, which means that the fourth output control unit 150 may transmit the third level signal VGL to the seventh node N7 in response to the signal at the second node N2.

Still referring to FIG. 16, based on the above embodiment, optionally, the output control module 10 further includes an eleventh transistor T11. A first electrode of the eleventh transistor T11 is connected to the first node N1, a second electrode of the eleventh transistor T11 is connected to the third node N3, and the eleventh transistor T11 remains in a normally conducted state, to transmit the signal at the first node N1 to the third node N3 through the eleventh transistor T11. In another embodiment, it may alternatively be configured that the first node N1 is directly connected to the third node N3, so that the signal at the first node N1 can be directly transmitted to the third node N3.

The output control module 10 further includes a twelfth transistor T12. The twelfth transistor T12 is connected between the fourth node N4 and the seventh node N7, and the twelfth transistor T12 remains in a normally conducted state, so that the signal at the fourth node N4 is transmitted to the gate of the first transistor T1 through the twelfth transistor T12. In another embodiment, it may alternatively be configured that the fourth node N4 is directly connected to the gate of the first transistor T1, so that the signal at the fourth node N4 can be directly transmitted to the gate of the first transistor T1.

The output control module 10 further includes a thirteenth transistor T13. A first electrode of the thirteenth transistor T13 is connected to the second electrode of the eleventh transistor T11, a second electrode of the thirteenth transistor T13 is connected to the fifth node N5, and the thirteenth transistor T13 remains in a normally conducted state, so that the signal at the first node N1 is transmitted to the fifth node N5 through the thirteenth transistor T13. In another embodiment, it may alternatively be configured that the first node N1 is directly connected to the fifth node N5, so that the signal at the first node N1 can be directly transmitted to the fifth node N5.

The output control module 10 further includes a fourteenth transistor T14. The fourteenth transistor T14 is connected between the second node N2 and the sixth node N6, and the fourteenth transistor T14 remains in a normally conducted state, so that the signal at the second node N2 is transmitted to the sixth node N6 through the fourteenth transistor T14. In another embodiment, it may alternatively be configured that the second node N2 is directly connected to the sixth node N6, so that the signal at the second node N2 can be directly transmitted to the sixth node N6.

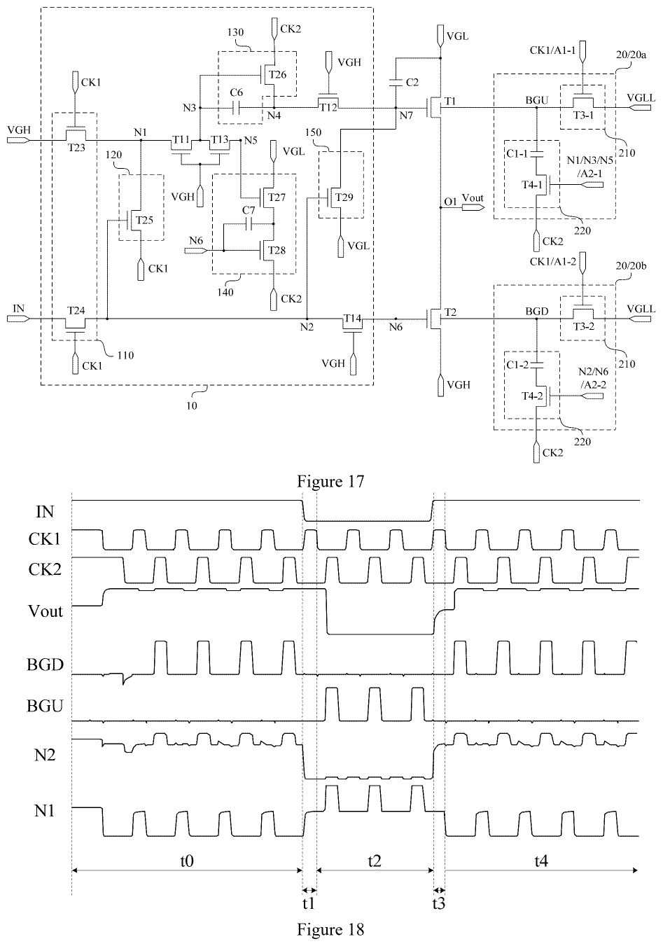

FIG. 17 is a schematic diagram of a structure of another gate drive circuit according to an embodiment of the present application. Referring to FIG. 17, based on the above embodiment, optionally, the input unit 110 includes a twenty-third transistor T23 and a twenty-fourth transistor T24. A gate of the twenty-third transistor T23 is connected to the first clock signal CK1, a first electrode of the twenty-third transistor T23 is connected to the second level signal VGH, and a second electrode of the twenty-third transistor T23 is connected to the first node N1. A gate of the twenty-fourth transistor T24 is connected to the first clock signal CK1, a first electrode of the twenty-fourth transistor T24 is connected to the start signal IN, and a second electrode of the twenty-fourth transistor T24 is connected to the second node N2. The first output control unit 120 includes a twenty-fifth transistor T25. A gate of the twenty-fifth transistor T25 is connected to the second node N2, a first electrode of the twenty-fifth transistor T25 is connected to the first clock signal CK1, and a second electrode of the twenty-fifth transistor T25 is connected to the first node N1. The second output control unit 130 includes a twenty-sixth transistor T26 and a sixth capacitor C6. A gate of the twenty-sixth transistor T26 is connected to the third node N3, a first electrode of the twenty-sixth transistor T26 is connected to the second clock signal CK2, and a second electrode of the twenty-sixth transistor T26 is connected to the fourth node N4. The sixth capacitor C6 is connected between the third node N3 and the fourth node N4. The third output control unit 140 includes a twenty-seventh transistor T27, a twenty-eighth transistor T28, and a seventh capacitor C7. A gate of the twenty-seventh transistor T27 is connected to the fifth node N5, and a first electrode of the twenty-seventh transistor T27 is connected to the third level signal VGL. A gate of the twenty-eighth transistor T28 is connected to the sixth node N6, a first electrode of the twenty-eighth transistor T28 is connected to the second clock signal CK2, and a second electrode of the twenty-eighth transistor T28 is connected to a second electrode of the twenty-seventh transistor T27. The seventh capacitor C7 is connected between the gate and the second electrode of the twenty-eighth transistor T28. The fourth output control unit 150 includes a twenty-ninth transistor T29. A gate of the twenty-ninth transistor T29 is connected to the second node N2, a first electrode of the twenty-ninth transistor T29 is connected to the third level signal VGL, and a second electrode of the twenty-ninth transistor T29 is connected to the seventh node N7.

In a case in which a plurality of transistors in the gate drive circuit are all N-type transistors, when the twenty-sixth transistor T26 is conducted in response to a high level signal at the third node N3, the second clock signal CK2 is transmitted to the fourth node N4 through the twenty-sixth transistor T26. Due to a coupling function, the sixth capacitor C6 can couple the signal at the third node N3 based on a level jump of the second clock signal CK2 at the fourth node N4, and couple a signal level of the third node N3 to an extremely high level that is greater than a high level, to increase a degree of conduction of the twenty-sixth transistor T26. This ensures that the twenty-sixth transistor T26 transmits the second clock signal CK2 to the fourth node N4, thereby controlling a voltage of a first gate of the first transistor T1, and enabling the first transistor T1 to operate normally. Disposing the eleventh transistor T11 and the thirteenth transistor T13 helps block the extremely high level of the third node N3 through the eleventh transistor T11, to avoid transmitting the extremely high level of the third node N3 to the twenty-third transistor T23 and the twenty-fifth transistor T25, thereby not affecting the operation of the twenty-third transistor T23 and the twenty-fifth transistor T25, and helps block the extremely high level of the third node N3 through the thirteenth transistor T13, to avoid transmitting the extremely high level of the third node N3 to the fifth node N5, thereby not causing damage to the twenty-seventh transistor T27 and not affecting the operation of the twenty-seventh transistor T27. In addition, when the output control module 10 controls the second transistor T2 to be conducted, the signal at the sixth node N6 is a high level signal, to conduct the twenty-eighth transistor T28. The second clock signal CK2 is transmitted to the seventh capacitor C7 through the twenty-eighth transistor T28. Due to a coupling function, the seventh capacitor C7 can couple the signal at the sixth node N6 based on a level jump of the second clock signal CK2 at the second electrode of the twenty-eighth transistor T28, and couple a signal level of the sixth node N6 to an extremely high level that is greater than a high level, to increase a degree of conduction of the second transistor T2. This ensures that the second level signal VGH can be transmitted to an output terminal O1 of the gate drive circuit through the second transistor T2. Disposing the fourteenth transistor T14 helps block the extremely high level of the sixth node N6 through the fourteenth transistor T14, to avoid transmitting the extremely high level of the sixth node N6 to the twenty-fourth transistor T24, the twenty-eighth transistor T28, and the twenty-ninth transistor T29, thereby not affecting the operation of the twenty-fourth transistor T24, the twenty-eighth transistor T28, and the twenty-ninth transistor T29. When a plurality of transistors in the gate drive circuit are all P-type transistors, the above transistors and capacitors can also achieve similar effects. The principle is not described again.

Still referring to FIG. 17, optionally, a first control signal includes a first clock signal CK1, and a preset signal includes a second clock signal CK2. A frequency of the first clock signal CK1 is the same as a frequency of the second clock signal CK2, and a phase of the first clock signal CK1 is opposite to a phase of the second clock signal CK2. When the first transistor T1 is a dual-gate transistor, a voltage regulation module 20 includes a first voltage regulation module 20a. When the second transistor T2 is a dual-gate transistor, the voltage regulation module 20 includes a second voltage regulation module 20b. The first clock signal CK1 is reused as a first control signal A1-1 in the first voltage regulation module 20a and a first control signal A1-2 in the second voltage regulation module 20b. The signal at the first node N1, the signal at the third node N3, or the signal at the fifth node N5 is reused as a second control signal A2-1 in the first voltage regulation module 20a. The second clock signal CK2 or the second level signal VGH is reused as a preset signal in the first voltage regulation module 20a and the second voltage regulation module 20b. A signal at a first gate of the second transistor T2 or a signal synchronized with the signal at the first gate of the second transistor T2 in terms of changes in high levels and low levels is reused as a second control signal A2-2 in the second voltage regulation module 20b. The signal at the second node N2 or the signal at the sixth node N6 is reused as the second control signal A2-2 in the second voltage regulation module 20b.

FIG. 18 is a schematic diagram of driving timing of a gate drive circuit according to an embodiment of the present application. The driving timing is applicable to driving the gate drive circuit shown in FIG. 16 and FIG. 17 to operate. With reference to FIG. 17 and FIG. 18, a working principle of the gate drive circuit is described below by using an example in which a plurality of transistors in the gate drive circuit are all N-type transistors. The first level signal VGLL is a preset low level signal, the second level signal VGH is a preset high level signal, and the third level signal VGL is a low level signal.

In a phase t0, the start signal IN is a high level signal, the first transistor T1 is cut off, the second transistor T2 is conducted, the second level signal VGH is transmitted to the output terminal O1 of the gate drive circuit through the second transistor T2, and a gate drive signal Vout output by the gate drive circuit is a high level signal. The signal at the second node N2 and the signal at the sixth node N6 are both high level signals. A fourth transistor T4-2 in the second voltage regulation module 20b is conducted in response to the signal at the second node N2 or the signal at the sixth node N6, to transmit the second clock signal CK2 to a first capacitor C1-2 through the fourth transistor T4-2, so that the first capacitor C1-2 couples a potential of a second gate of the second transistor T2 when a level of the second clock signal CK2 jumps from a low level to a high level. In this way, a voltage of the second gate of the second transistor T2 can be raised, to make a threshold voltage of the second transistor T2 tend to be negative, thereby improving a driving capability of the second transistor T2, and solving the problem of waveform distortion of the gate drive signal.

In a phase t1, the first transistor T1 remains cut off, the second transistor T2 remains conducted, and the gate drive signal Vout output by the gate drive circuit is still a high level signal. A falling edge of the start signal IN and a rising edge of the first clock signal CK1 arrive. The twenty-third transistor T23 and a third transistor T3-1 in the first voltage regulation module 20a are conducted. The first level signal VGLL is transmitted to a BGU node through the third transistor T3-1, to reset a voltage of the BGU node. The second level signal VGH is input to the first node N1, the third node N3, and the fifth node N5, and a signal at the first node N1, a signal at the third node N3, and a signal at the fifth node N5 are all high level signals. A fourth transistor T4-1 in the first voltage regulation module 20a is conducted in response to the signal at the first node N1, the signal at the third node N3, or the signal at the fifth node N5. A low level in the second clock signal CK2 is transmitted to a first electrode of a first capacitor C1-1 in the first voltage regulation module 20a, to reset a voltage of the first electrode of the first capacitor C1-1.

In a phase t2, the start signal IN is a low level signal. The second transistor T2 changes from a conducted state to a cut-off state, and the first transistor T1 changes from a cut-off state to a conducted state. The third level signal VGL is transmitted to the output terminal O1 of the gate drive circuit through the first transistor T1, and the gate drive signal Vout output by the gate drive circuit changes from a high level signal to a low level signal. After the first transistor T1 is conducted, the signal at the first node N1, the signal at the third node N3, and the signal at the fifth node N5 are all high level signals, and the fourth transistor T4-1 in the first voltage regulation module 20a is conducted in response to the signal at the first node N1, the signal at the third node N3, or the signal at the fifth node N5, to transmit the second clock signal CK2 to the first electrode of the first capacitor C1-1. When the third transistor T3-1 in the first voltage regulation module 20a is cut off in response to a low level in the first clock signal CK1, the second clock signal CK2 jumps from a low level to a high level. The first capacitor C1-1 can couple a potential of the BGU node in response to a level jump of the second clock signal CK2, to raise the voltage of the BGU node and in turn make a threshold voltage of the first transistor T1 tend to be negative, thereby improving a driving capability of the first transistor T1. In this way, the gate drive signal Vout output by the gate drive circuit rapidly transitions from a high level signal to a low level signal, which helps reduce a waveform delay of the gate drive signal Vout, and therefore solves the problem of waveform distortion of the gate drive signal. At the same time, a signal at the second node N2 and a signal at the sixth node N6 are both low level signals. The fourth transistor T4-2 in the second voltage regulation module 20b is cut off in response to the signal at the second node N2 or the signal at the sixth node N6. When a third transistor T3-2 is conducted in response to a high level in the first clock signal CK1, the first level signal VGLL is transmitted to a BGD node through the third transistor T3-2, and a voltage of the BGD node is maintained through the first capacitor C1-2, so that the second gate of the second transistor T2 transmits the first level signal VGLL, to reduce the voltage of the second gate of the second transistor T2 and in turn make the threshold voltage of the second transistor T2 tend to be positive. This helps ensure that the second transistor T2 is completely cut off, to suppress a leakage current of the second transistor T2, thereby reducing power consumption of the second transistor T2 caused by the leakage current, and solving the problem of waveform distortion of the gate drive signal.

In a phase t3, a rising edge of the start signal IN and a rising edge of the first clock signal CK1 arrive. The twenty-fourth transistor T24 and the third transistor T3-2 in the second voltage regulation module 20b are conducted. The first level signal VGLL is transmitted to the BGD node through the third transistor T3-2, to reset the voltage of the BGD node. The second level signal VGH is input to the second node N2 and the sixth node N6, and the signal at the second node N2 and the signal at the sixth node N6 are both high level signals. The fourth transistor T4-2 in the second voltage regulation module 20b is conducted in response to the signal at the second node N2 or the signal at the sixth node N6. The low level in the second clock signal CK2 is transmitted to a first electrode of the first capacitor C1-2, to reset a voltage of the first electrode of the first capacitor C1-2.

In a phase t4, the start signal IN is a high level signal. The first transistor T1 changes from the conducted state to the cut-off state, and the second transistor T2 changes from the cut-off state to the conducted state. The second level signal VGH is transmitted to the output terminal O1 of the gate drive circuit through the second transistor T2, and the gate drive signal Vout output by the gate drive circuit changes from a low level signal to a high level signal. After the second transistor T2 is conducted, the signal at the second node N2 and the signal at the sixth node N6 are both high level signals, and the fourth transistor T4-2 in the second voltage regulation module 20b is conducted in response to the signal at the second node N2 or the signal at the sixth node N6, to transmit the second clock signal CK2 to the first electrode of the first capacitor C1-2. When the third transistor T3-2 in the second voltage regulation module 20b is cut off in response to the low level in the first clock signal CK1, the second clock signal CK2 jumps from a low level to a high level. The first capacitor C1-2 can couple a potential of the BGD node in response to a level jump of the second clock signal CK2, to raise the voltage of the BGD node and in turn make the threshold voltage of the second transistor T2 tend to be negative, thereby improving the driving capability of the second transistor T2. In this way, the gate drive signal Vout output by the gate drive circuit rapidly transitions from a low level signal to a high level signal, which helps reduce the waveform delay of the gate drive signal Vout, and therefore solves the problem of waveform distortion of the gate drive signal. At the same time, the signal at the first node N1, the signal at the third node N3, and the signal at the fifth node N5 are all low level signals, and the fourth transistor T4-1 in the first voltage regulation module 20a is cut off in response to the signal at the first node N1, the signal at the third node N3, or the signal at the fifth node N5. When the third transistor T3-1 is conducted in response to the high level in the first clock signal CK1, the first level signal VGLL is transmitted to the BGU node through the third transistor T3-1, and the voltage of the BGU node is maintained through the first capacitor C1-1, so that a second gate of the first transistor T1 transmits the first level signal VGLL, to reduce a voltage of the second gate of the first transistor T1 and in turn make the threshold voltage of the first transistor T1 tend to be positive. This helps ensure that the first transistor T1 is completely cut off, to suppress a leakage current of the first transistor T1, thereby reducing power consumption of the first transistor T1 caused by the leakage current, and solving the problem of waveform distortion of the gate drive signal.

When a plurality of transistors in the gate drive circuit are all P-type transistors, the first level signal VGLL is a preset high level signal, the second level signal VGH is a preset low level signal, and the third level signal VGL is a high level signal. A working principle of the gate drive circuit is similar to that in the above embodiment. Details are not described again.

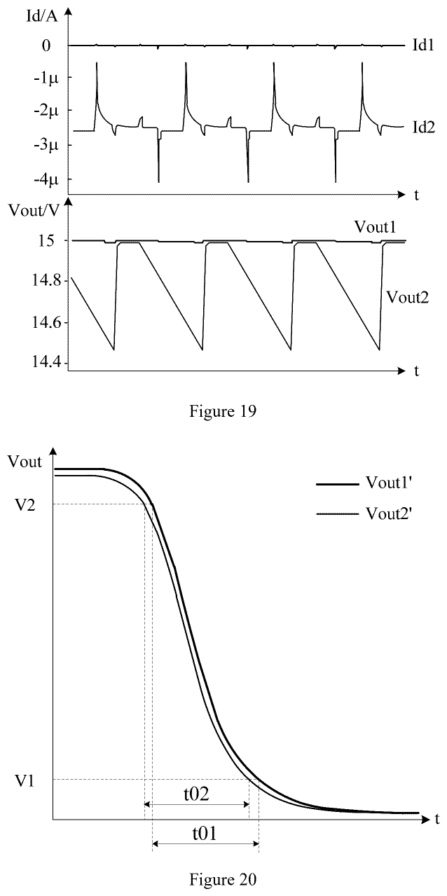

FIG. 19 is a schematic diagram of a comparison between waveforms of leakage currents and a comparison between waveforms of gate drive signals according to an embodiment of the present application. The horizontal axes represent time t, and the vertical axes represent a leakage current Id and a gate drive signal Vout output by an output terminal of a gate drive circuit. A unit of the leakage current Id is ampere (A), and a unit of the gate drive signal Vout is volt (V). With reference to FIG. 17 and FIG. 19, Id1 represents a leakage current of the first transistor T1 in the embodiments of the present application, and Id2 represents a leakage current of an output transistor of a gate drive circuit in the related art. When the first transistor T1 and the output transistor of the gate drive circuit in the related art are both N-type transistors, a threshold voltage of the output transistor of the gate drive circuit in the related art tends to be negative, and the leakage current of the output transistor is large. However, in the embodiments of the present application, the leakage current Id1 of the first transistor T1 can be greatly reduced. Vout1 represents a high level signal in the gate drive signal output by the gate drive circuit in the embodiments of the present application, and Vout2 represents a high level signal in the gate drive signal output by the gate drive circuit in the related art. It can be learned that the high level signal output by the gate drive circuit provided in the embodiments of the present application is more stable than that in the related art.

FIG. 20 is a schematic diagram of a comparison between waveforms of gate drive signals according to an embodiment of the present application. The horizontal axis represents time t, and the vertical axis represents a gate drive signal Vout output by an output terminal of a gate drive circuit. Vout1′ represents a falling edge waveform of a gate drive signal output by a gate drive circuit in the embodiments of the present application. Vout2′ represents a falling edge waveform of a gate drive signal output by a gate drive circuit in the related art. In Vout1′, time t01 required for a voltage of the gate drive signal to decrease from V2 to V1 is approximately equal to 374.18 ns. In Vout2′, time t02 required for a voltage of the gate drive signal to decrease from V2 to V1 is approximately equal to 373.89 ns. It can be learned that a falling edge delay of the gate drive signal output by the gate drive circuit provided in the embodiments of the present application is close to that of the gate drive signal output by the gate drive circuit in related art, which ensures a driving capability of a first transistor T1 and a driving capability of a second transistor T2 while reducing a leakage current of the first transistor T1 and a leakage current of the second transistor T2.

Based on the plurality of embodiments described above, when a dual-gate transistor as the first transistor T1 and the second transistor T2 is an N-type transistor, a potential of the first level signal VGLL is less than or equal to a minimum potential in potentials of the first output signal and the second output signal. One of the first output signal and the second output signal is a high level signal, and the other of the first output signal and the second output signal is a low level signal. The minimum potential in potentials of the first output signal and the second output signal is a potential of the low level signal. For example, referring to FIG. 17, when the third level signal VGL is used as the first output signal, and the second level signal VGH is used as the second output signal, a potential of the third level signal VGL is less than a potential of the second level signal VGH, and a potential of the first level signal VGLL is less than or equal to the potential of the third level signal VGL. A level corresponding to the third level signal VGL may be a low level that normally controls a transistor to be conducted or cut off. For example, a voltage of the third level signal VGL may be a voltage of about −5 V to −7 V. A level of the first level signal VGLL, namely a preset low level, may be a low level that is more negative than the level of the third level signal VGL. For example, a voltage of the first level signal VGLL may be less than the voltage of the third level signal VGL by about 0.5 V to 5 V. The reason for configuring like this is that, when a voltage of a second gate of the dual-gate transistor as the first transistor T1 and the second transistor T2 is regulated through the first level signal VGLL, a lower level of the first level signal VGLL can make a threshold voltage of the dual-gate transistor tend to be positive, which helps ensure that the dual-gate transistor is completely cut off, to suppress a leakage current of the dual-gate transistor. In another embodiment, it may alternatively be configured that the potential of the first level signal VGLL is equal to the potential of the third level signal VGL, so that the third level signal VGL can be reused as the first level signal VGLL, to reduce the number of signal terminals in a display panel.

Similarly, when a dual-gate transistor as the first transistor T1 and the second transistor T2 is a P-type transistor, a potential of the first level signal VGLL is greater than or equal to a maximum potential in potentials of the first output signal and the second output signal. One of the first output signal and the second output signal is a high level signal, and the other of the first output signal and the second output signal is a low level signal. The maximum potential in potentials of the first output signal and the second output signal is a potential of the high level signal. For example, when the third level signal VGL is used as the first output signal, and the second level signal VGH is used as the second output signal, a potential of the third level signal VGL is greater than a potential of the second level signal VGH, and a potential of the first level signal VGLL is greater than or equal to the potential of the third level signal VGL. A level corresponding to the third level signal VGL may be a high level that normally controls a transistor to be conducted or cut off. For example, a voltage of the third level signal VGL may be a voltage of about 3.5 V to 5 V. A level of the first level signal VGLL, namely a preset high level, may be a high level that is greater than the level of the third level signal VGL. For example, a voltage of the first level signal VGLL may be greater than the voltage of the third level signal VGL by about 0.5 V to 5 V. In this way, regulating a voltage of a second gate of the dual-gate transistor as the first transistor T1 and the second transistor T2 through the first level signal VGLL also helps ensure that the dual-gate transistor is completely cut off, thereby suppressing a leakage current of the dual-gate transistor. In another embodiment, it may alternatively be configured that the potential of the first level signal VGLL is equal to the potential of the third level signal VGL, so that the third level signal VGL can be reused as the first level signal VGLL, to reduce the number of signal terminals in a display panel.

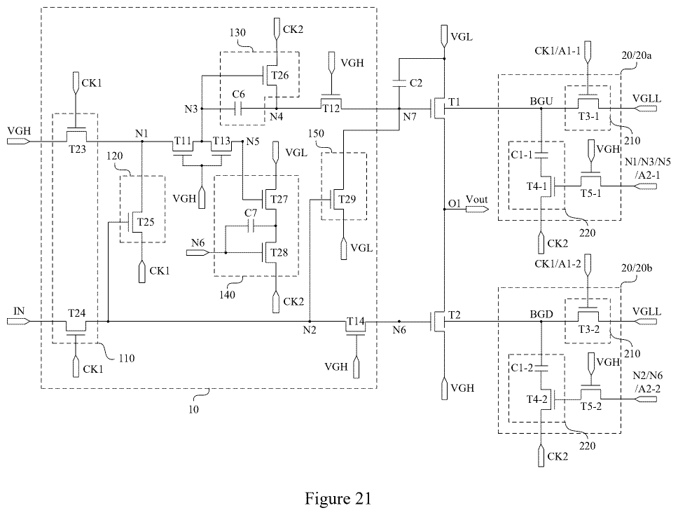

FIG. 21 is a schematic diagram of a structure of another gate drive circuit according to an embodiment of the present application. Referring to FIG. 21, in the gate drive circuit, a first voltage regulation module 20a further includes a fifth transistor T5-1, and a second voltage regulation module 20b further includes a fifth transistor T5-2. Disposing the fifth transistor T5-1 in a normally conducted state between a gate of a fourth transistor T4-1 and a corresponding second control signal terminal (i.e., a first node N1, a third node N3, or a fifth node N5) helps block an extremely high level of the first node N1, the third node N3, and the fifth node N5, to avoid transmitting the extremely high level to the fourth transistor T4-1, thereby not affecting the operation of the fourth transistor T4-1. Disposing the fifth transistor T5-2 in the normally conducted state between the gate of the fourth transistor T4-2 and a corresponding second control signal terminal (i.e., a second node N2 or a sixth node N6) helps block an extremely high level of the second node N2 and the sixth node N6, to avoid transmitting the extremely high level to the fourth transistor T4-2, thereby not affecting the operation of the fourth transistor T4-2.

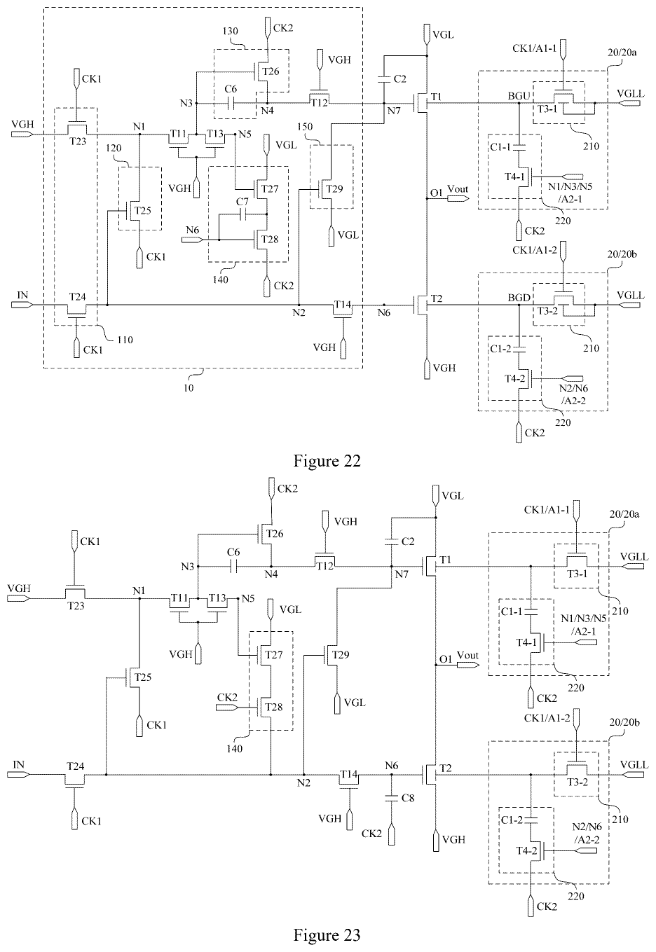

FIG. 22 is a schematic diagram of a structure of another gate drive circuit according to an embodiment of the present application. Referring to FIG. 22, in the gate drive circuit, a third transistor T3-1 in a first voltage regulation module 20a is a dual-gate transistor. A first gate of the third transistor T3-1 is connected to a first control signal A1-1, and a second gate of the third transistor T3-1 is connected to a first electrode of the third transistor T3-1 to be connected to a first level signal VGLL. A third transistor T3-2 in a second voltage regulation module 20b is a dual-gate transistor. A first gate of the third transistor T3-2 is connected to a first control signal A1-2, and a second gate of the third transistor T3-2 is connected to a first electrode of the third transistor T3-2 to be connected to a first level signal VGLL. The second gate of the third transistor T3-1 is connected to the first level signal VGLL, so that a potential of the second gate of the third transistor T3-1 can be regulated, to regulate a threshold voltage of the third transistor T3-1, and ensure that the third transistor T3-1 is in a cut-off state when a voltage of the first gate of the third transistor T3-1 remains unchanged. This avoids a case in which the third transistor T3-1 is not in a completely cut-off state, resulting in a large leakage current and consequently affecting a voltage of a second gate of a first transistor T1, thereby not affecting a driving capability of the first transistor T1. Similarly, the second gate of the third transistor T3-2 is connected to the first level signal VGLL, so that the potential of the second gate of the third transistor T3-2 can be regulated, to regulate the threshold voltage of the third transistor T3-2, and ensure that the third transistor T3-2 is in the cut-off state when the voltage of the first gate of the third transistor T3-2 remains unchanged. This avoids a case in which the third transistor T3-2 is not in the completely cut-off state, resulting in a large leakage current and consequently affecting a voltage of a second gate of a second transistor T2, thereby not affecting a driving capability of the second transistor T2.

FIG. 23 is a schematic diagram of a structure of another gate drive circuit according to an embodiment of the present application. A difference between the gate drive circuit shown in FIG. 23 and the gate drive circuit shown in FIG. 17 is that no seventh capacitor C7 needs to be disposed in a third output control unit 140, a gate of a twenty-eighth transistor T28 is connected to a second clock signal CK2, and a first electrode of the twenty-eighth transistor T28 is connected to a second node N2, to transmit a third level signal VGL to the second node N2 through the third output control unit 140 in response to a signal at a fifth node N5 and the second clock signal CK2. In addition, the gate drive circuit further includes an eighth capacitor C8. A first electrode of the eighth capacitor C8 is connected to the second clock signal CK2, and a second electrode of the eighth capacitor C8 is connected to a sixth node N6. The eighth capacitor C8 can couple a signal at the sixth node N6 based on a level jump of the second clock signal CK2.

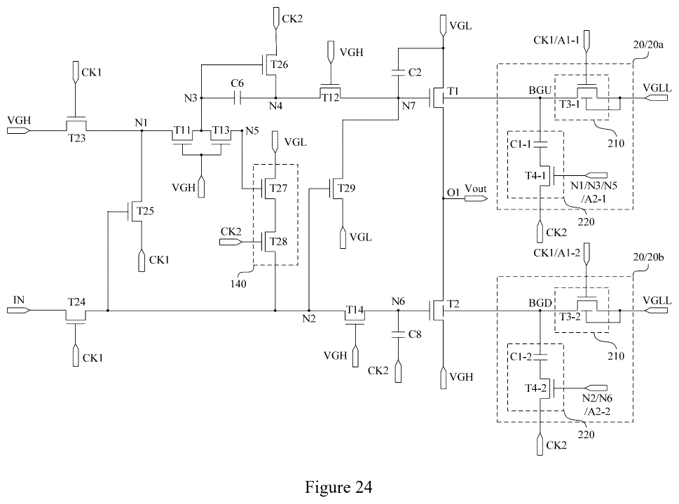

FIG. 24 is a schematic diagram of a structure of another gate drive circuit according to an embodiment of the present application. A difference between the gate drive circuit shown in FIG. 24 and the gate drive circuit shown in FIG. 23 is that a third transistor T3-1 in a first voltage regulation module 20a is a dual-gate transistor. A first gate of the third transistor T3-1 is connected to a first control signal A1-1, and a second gate of the third transistor T3-1 is connected to a first electrode of the third transistor T3-1 to be connected to a first level signal VGLL. A third transistor T3-2 in a second voltage regulation module 20b is a dual-gate transistor. A first gate of the third transistor T3-2 is connected to a first control signal A1-2, and a second gate of the third transistor T3-2 is connected to a first electrode of the third transistor T3-2 to be connected to a first level signal VGLL. The second gate of the third transistor T3-1 is connected to the first level signal VGLL, so that a potential of the second gate of the third transistor T3-1 can be regulated, to regulate a threshold voltage of the third transistor T3-1, and ensure that the third transistor T3-1 is in a cut-off state when a voltage of the first gate of the third transistor T3-1 remains unchanged. This avoids a case in which the third transistor T3-1 is not in a completely cut-off state, resulting in a large leakage current and consequently affecting a voltage of a second gate of a first transistor T1, thereby not affecting a driving capability of the first transistor T1. Similarly, the second gate of the third transistor T3-2 is connected to the first level signal VGLL, so that the potential of the second gate of the third transistor T3-2 can be regulated, to regulate the threshold voltage of the third transistor T3-2, and ensure that the third transistor T3-2 is in the cut-off state when the voltage of the first gate of the third transistor T3-2 remains unchanged. This avoids a case in which the third transistor T3-2 is not in the completely cut-off state, resulting in a large leakage current and consequently affecting a voltage of a second gate of a second transistor T2, thereby not affecting a driving capability of the second transistor T2.

An embodiment of the present application further provides a display panel, including the gate drive circuit in any above embodiment. There are a plurality of gate drive circuits, and the plurality of gate drive circuits are connected in a cascading manner. The display panel may be an organic light-emitting diode (OLED) display panel or a micro light-emitting diode (micro-LED) display panel. A plurality of gate drive circuits are connected in a cascading manner. For example, an input terminal of a first-stage gate drive circuit is connected to a start signal, and an output terminal of a previous-stage gate drive circuit is connected to an input terminal of a next-stage gate drive circuit, so that an output signal of the previous-stage gate drive circuit can be used as an input signal of the next-stage gate drive circuit, and the plurality of stages of gate drive circuits can output gate drive signals with sequentially delayed timings stage by stage.

The display panel includes a plurality of pixel circuits and light-emitting devices. The pixel circuit may include a thin-film transistor and a storage capacitor. The thin-film transistor includes a drive transistor and a switch transistor. When the switch transistor in the pixel circuit is conducted, a data voltage may be transmitted to the storage capacitor, and the data voltage is stored by the storage capacitor, so that the drive transistor can generate a drive current based on the data voltage stored by the storage capacitor, to drive the light-emitting device to emit light for display. The gate drive signal output by the gate drive circuit may be used to drive the switch transistor in the pixel circuit to operate.

The display panel provided in this embodiment of the present application includes the gate drive circuit in any embodiment of the present application, and therefore has a corresponding functional module of the gate drive circuit. Details are not described herein again.

It should be understood that a plurality of forms of processes described above can be used to reorder, add, or delete steps. For example, the steps described in the present application may be performed in parallel, or may be performed in sequence, or may be performed in different sequences, provided that an expected result of the embodiments of the present application can be implemented, which is not limited herein.

What is claimed is:

1. A gate drive circuit, comprising:
an output control module;
a first transistor;
a second transistor, wherein the output control module is connected to a gate of the first transistor and a gate of the second transistor, a first electrode of the first transistor is configured to receive a first output signal, a second electrode of the first transistor is connected to an output terminal of the gate drive circuit, a first electrode of the second transistor is configured to receive a second output signal, a second electrode of the second transistor is connected to the output terminal of the gate drive circuit, the output control module is configured to control the first transistor and the second transistor to be alternately turned on, to alternately transmit the first output signal and the second output signal to the output terminal of the gate drive circuit, at least one of the first transistor and the second transistor is a dual-gate transistor, and a first gate of the dual-gate transistor is connected to the output control module; and
a voltage regulation module connected to a second gate of the dual-gate transistor and configured to regulate a voltage of the second gate of the dual-gate transistor.

2. The gate drive circuit according to claim 1, wherein the voltage regulation module is configured to: regulate the voltage of the second gate of the dual-gate transistor when the dual-gate transistor is conducted, to improve a driving capability of the dual-gate transistor, and regulate the voltage of the second gate of the dual-gate transistor when the dual-gate transistor is cut off, to suppress a leakage current of the dual-gate transistor; or regulate the voltage of the second gate of the dual-gate transistor when the dual-gate transistor is conducted, to improve a driving capability of the dual-gate transistor, and regulate the voltage of the second gate of the dual-gate transistor when the dual-gate transistor is cut off, to suppress a leakage current of the dual-gate transistor.

3. The gate drive circuit according to claim 1, wherein a control terminal of the voltage regulation module is configured to receive a first control signal, a first terminal of the voltage regulation module is configured to receive a first level signal, and a second terminal of the voltage regulation module is connected to the second gate of the dual-gate transistor; the voltage regulation module is configured to transmit the first level signal to the second gate of the dual-gate transistor in response to the first control signal when the dual-gate transistor is cut off, to suppress a leakage current of the dual-gate transistor; and
the voltage regulation module comprises a third transistor, wherein a gate of the third transistor is configured to receive the first control signal, a first electrode of the third transistor is configured to receive the first level signal, and a second electrode of the third transistor is connected to the second gate of the dual-gate transistor.

4. The gate drive circuit according to claim 1, wherein a control terminal of the voltage regulation module is configured to receive a second control signal, a first terminal of the voltage regulation module is configured to receive a preset signal, and a second terminal of the voltage regulation module is connected to the second gate of the dual-gate transistor; the voltage regulation module is configured to regulate, through the preset signal, the voltage of the second gate of the dual-gate transistor in response to the second control signal when the dual-gate transistor is conducted, to improve a driving capability of the dual-gate transistor; and
the voltage regulation module comprises a fourth transistor, wherein a gate of the fourth transistor is configured to receive the second control signal, a first electrode of the fourth transistor is configured to receive the preset signal, and the fourth transistor is configured to transmit a signal related to the preset signal to the second gate of the dual-gate transistor in response to the second control signal.

5. The gate drive circuit according to claim 4, wherein the voltage regulation module further comprises a first capacitor, and the first capacitor is connected between a second electrode of the fourth transistor and the second gate of the dual-gate transistor.

6. The gate drive circuit according to claim 4, wherein the voltage regulation module further comprises a fifth transistor, the second control signal is connected to the gate of the fourth transistor through the fifth transistor, and the fifth transistor remains in a normally conducted state.

7. The gate drive circuit according to claim 1, wherein the voltage regulation module comprises:
a first voltage regulation unit, wherein a control terminal of the first voltage regulation unit is configured to receive a first control signal, a first terminal of the first voltage regulation unit is configured to receive a first level signal, a second terminal of the first voltage regulation unit is connected to the second gate of the dual-gate transistor, and the first voltage regulation unit is configured to transmit the first level signal to the second gate of the dual-gate transistor in response to the first control signal when the dual-gate transistor is cut off; and
a second voltage regulation unit, wherein a control terminal of the second voltage regulation unit is configured to receive a second control signal, a first terminal of the second voltage regulation unit is configured to receive a preset signal, a second terminal of the second voltage regulation unit is connected to the second gate of the dual-gate transistor, and the second voltage regulation unit is configured to regulate, through the preset signal, the voltage of the second gate of the dual-gate transistor in response to the second control signal when the dual-gate transistor is conducted; and
a level of the first level signal comprises a first level, a level of the preset signal comprises a second level, one of the first level and the second level is a preset high level, and the other of the first level and the second level is a preset low level.

8. The gate drive circuit according to claim 7, wherein the first voltage regulation unit comprises a third transistor, and the second voltage regulation unit comprises a fourth transistor;
a gate of the third transistor is connected to the first control signal, a first electrode of the third transistor is connected to the first level signal, and a second electrode of the third transistor is connected to the second gate of the dual-gate transistor; a gate of the fourth transistor is configured to receive the second control signal, a first electrode of the fourth transistor is configured to receive the preset signal, and the fourth transistor is configured to transmit a signal related to the preset signal to the second gate of the dual-gate transistor in response to the second control signal;
the second voltage regulation unit further comprises a first capacitor, and the first capacitor is connected between a second electrode of the fourth transistor and the second gate of the dual-gate transistor;
the dual-gate transistor is an N-type transistor, the first level is the preset low level, and the second level is the preset high level; or
the dual-gate transistor is a P-type transistor, the first level is the preset high level, and the second level is the preset low level.

9. The gate drive circuit according to claim 7, wherein the first control signal comprises a first clock signal, the preset signal comprises a second clock signal, and a phase of the first clock signal is opposite to a phase of the second clock signal.

10. The gate drive circuit according to claim 3, wherein the third transistor is a dual-gate transistor;
a first gate of the third transistor is configured to receive the first control signal, and a second gate of the third transistor is configured to receive the first level signal; or
a second gate of the third transistor is configured to receive the first control signal, and a first gate of the third transistor is configured to receive the first level signal.

11. The gate drive circuit according to claim 1, wherein when the first transistor is the dual-gate transistor, the voltage regulation module comprises a first voltage regulation module, and the first voltage regulation module is connected to a second gate of the first transistor; and
when the second transistor is the dual-gate transistor, the voltage regulation module comprises a second voltage regulation module, and the second voltage regulation module is connected to a second gate of the second transistor.

12. The gate drive circuit according to claim 11, wherein the first transistor and the second transistor are both dual-gate transistors; and
the second gate of the first transistor is connected to the first voltage regulation module, and the second gate of the second transistor is connected to the second voltage regulation module.

13. The gate drive circuit according to claim 1, wherein the first transistor and the second transistor are both dual-gate transistors;
a second gate of one of the first transistor and the second transistor is connected to a first level signal line, and a second gate of the other of the first transistor and the second transistor is connected to the voltage regulation module; or
a first gate and a second gate of one of the first transistor and the second transistor are connected, and a second gate of the other of the first transistor and the second transistor is connected to the voltage regulation module.

14. The gate drive circuit according to claim 1, wherein the output control module comprises: an input unit connected to a first node, a second node, and an input terminal of the gate drive circuit and configured to control a signal at the first node and a signal at the second node based on a first clock signal, a second level signal, and a signal at the input terminal of the gate drive circuit;
a first output control unit connected to the first node and the second node and configured to control the signal at the first node based on the signal at the second node and the first clock signal; and
a second output control unit connected to the first node and the second node and configured to control the signal at the second node based on the signal at the first node, a second clock signal, and a third level signal, wherein the first node is connected to the gate of the first transistor, and the signal at the second node is transmitted to the gate of the second transistor; and
the third level signal is reused as the first output signal, and the second clock signal is reused as the second output signal.

15. The gate drive circuit according to claim 14, wherein the first output control unit comprises a seventh transistor, wherein a gate of the seventh transistor is connected to the second node, a first electrode of the seventh transistor is configured to receive the first clock signal, and a second electrode of the seventh transistor is connected to the first node; and
the second output control unit comprises an eighth transistor and a ninth transistor, wherein a gate of the eighth transistor is connected to the first node, a first electrode of the eighth transistor is configured to receive the third level signal, a second electrode of the eighth transistor is connected to a first electrode of the ninth transistor, a gate of the ninth transistor is configured to receive the second clock signal, and a second electrode of the ninth transistor is connected to the second node.

16. The gate drive circuit according to claim 15, wherein the gate drive circuit satisfies at least one of the following:
the seventh transistor is a dual-gate transistor, a first gate of the seventh transistor is connected to the second node, and a second gate of the seventh transistor is configured to receive a first level signal; and
the eighth transistor and the ninth transistor are both dual-gate transistors, a first gate of the eighth transistor is connected to the first node, a first gate of the ninth transistor is configured to receive the second clock signal, and a second gate of the eighth transistor and a second gate of the ninth transistor are both configured to receive the first level signal.

17. The gate drive circuit according to claim 1, wherein the output control module comprises:
an input unit connected to a first node, a second node, and an input terminal of the gate drive circuit and configured to control a signal at the first node and a signal at the second node based on a first clock signal, a third level signal, and a signal at the input terminal of the gate drive circuit;
a first output control unit connected to a third node, the first node, and the second node and configured to control a signal at the third node based on a second clock signal, the signal at the first node, the signal at the second node, and the third level signal, wherein the third node is connected to the gate of the first transistor; and
a second output control unit connected to a fourth node and the third node and configured to control a signal at the fourth node based on the signal at the third node, the signal at the fourth node, the third level signal, and the second clock signal, wherein the fourth node is connected to the gate of the second transistor, and the signal at the second node is transmitted to the gate of the second transistor; and
the third level signal is reused as the first output signal, and a second level signal is reused as the second output signal.

18. The gate drive circuit according to claim 1, wherein the output control module comprises:
an input unit connected to a first node, a second node, and an input terminal of the gate drive circuit and configured to control a signal at the first node and a signal at the second node based on a first clock signal, a second level signal, and a signal at the input terminal of the gate drive circuit;
a first output control unit connected to the first node and the second node and configured to control the signal at the first node based on the signal at the second node and the first clock signal;
a second output control unit connected to a third node and a fourth node and configured to control a signal at the fourth node based on a signal at the third node and a second clock signal, wherein the signal at the first node is transmitted to the third node, and the signal at the fourth node is transmitted to the gate of the first transistor;
a third output control unit connected to a fifth node and a sixth node and configured to control a signal at the sixth node based on a signal at the fifth node, the signal at the sixth node, a third level signal, and the second clock signal, wherein the signal at the first node is transmitted to the fifth node, the signal at the second node is transmitted to the sixth node, and the sixth node is connected to the gate of the second transistor; and
a fourth output control unit connected to a seventh node and the second node and configured to control a signal at the seventh node based on the signal at the second node and the third level signal, wherein the signal at the fourth node is transmitted to the seventh node, and the seventh node is connected to the gate of the first transistor; and wherein the third level signal is reused as the first output signal, and the second level signal is reused as the second output signal.

19. The gate drive circuit according to claim 3, wherein
when the dual-gate transistor is an N-type transistor, a potential of the first level signal is less than or equal to a minimum potential in potentials of the first output signal and the second output signal; and when the dual-gate transistor is a P-type transistor, a potential of the first level signal is greater than or equal to a maximum potential in potentials of the first output signal and the second output signal.

20. A display panel, comprising:
a plurality of gate drive circuits, comprising:
an output control module;
a first transistor;
a second transistor, wherein the output control module is connected to a gate of the first transistor and a gate of the second transistor, a first electrode of the first transistor is configured to receive a first output signal, a second electrode of the first transistor is connected to an output terminal of the plurality of gate drive circuits, a first electrode of the second transistor is configured to receive a second output signal, a second electrode of the second transistor is connected to the output terminal of the gate plurality of drive circuits, the output control module is configured to control the first transistor and the second transistor to be alternately turned on, to alternately transmit the first output signal and the second output signal to the output terminal of the plurality of gate drive circuits, at least one of the first transistor and the second transistor is a dual-gate transistor, and a first gate of the dual-gate transistor is connected to the output control module; and
a voltage regulation module connected to a second gate of the dual-gate transistor and configured to regulate a voltage of the second gate of the dual-gate transistor, wherein the plurality of gate drive circuits are connected in a cascading manner.
